(19) United States
(12) Patent Application Publication
(10) Pub. No.: US 2024/0332680 A1
(43) Pub. Date: Oct. 3, 2024

(54) POWER STORAGE DEVICE PACKAGING MATERIAL, METHOD FOR PRODUCING SAME, AND POWER STORAGE DEVICE

(71) Applicant: DAI NIPPON PRINTING CO., LTD., Tokyo (JP)

(72) Inventors: Makoto AMANO, Tokyo (JP); Masahiro TATSUZAWA, Tokyo (JP); Takanori YAMASHITA, Tokyo (JP)

(73) Assignee: DAI NIPPON PRINTING CO., LTD., Tokyo (JP)

(21) Appl. No.: 18/698,874

(22) PCT Filed: Sep. 21, 2022
(86) PCT No.: PCT/JP2022/035076

§ 371 Date: Jun. 12, 2024

(30) Foreign Application Priority Data
Oct. 7, 2021 (JP) 2021-165807

(51) Int. Cl. H01M 50/136; H01M 50/105; H01M 50/119; H01M 50/129

(52) U.S. Cl. CPC H01M 50/136; H01M 50/105; H01M 50/119; H01M 50/129

(57) ABSTRACT

A power storage device packaging material, including a laminate including at least a base material layer, a barrier layer, and a heat-sealable resin layer in this order from an outer side, wherein the barrier layer has a thickness of 38 μm or more, the laminate has a bending resistance of 1.1 mN or more, as measured under predetermined conditions in accordance with the provisions of JIS L1085: 1998, and the number of double folds until a pinhole is formed in the laminate is 600 or more, as measured under predetermined conditions in accordance with the provisions of JIS P8115: 2001.

### TECHNICAL FIELD

The present disclosure relates to a power storage device packaging material, a method for producing the same, and a power storage device.

### BACKGROUND ART

Various types of power storage devices have been heretofore developed. In every power storage device, a packaging material is an essential member for sealing a power storage device element including electrodes, an electrolyte, and the like. Metallic packaging materials have heretofore been widely used as power storage device packaging materials.

In recent years, along with improvements in the performance of electric cars, hybrid electric cars, personal computers, cameras, mobile phones, and the like, power storage devices have been required to be diversified in shape and also to be thinner and lighter weight. However, the widely used metallic power storage device packaging materials are disadvantageous in that they have difficulty in keeping up with the diversification of shapes and are limited in weight reduction.

Thus, a film-shaped laminate in which a base material layer/a barrier layer/a heat-sealable resin layer are laminated in this order has been recently proposed as a power storage device packaging material that can be readily processed into various shapes and can achieve a thickness reduction and a weight reduction (see, for example, Patent Literature 1).

In such a power storage device packaging material, commonly, a concave portion is formed by cold molding, a power storage device element including electrodes, an electrolytic solution, and the like is disposed in the space formed by the concave portion, and the heat-sealable resin layers are heat-sealed. This results in a power storage device in which the power storage device element is housed inside the power storage device packaging material.

### CITATION LIST

### Patent Literature

Patent Literature 1: JP-A-2008-287971

### SUMMARY OF INVENTION

### Technical Problem

In view of further increasing the energy density of a power storage device, for example, there is a need to form a deeper concave portion in the packaging material. Therefore, excellent moldability is required in the packaging material.

Additionally, along with a recent tendency toward an increased weight of a power storage device element, it is desirable to improve the folding endurance of the packaging material, in consideration of cases such as dropping of a power storage device. Furthermore, in a tablet terminal, for example, where space saving is highly required, the ends of the packaging material are fixed to the casing in a folded state. It should also be noted that large-size power storage devices, such as those for vehicle-mounted use and for stationary energy storage, employ heavy-weight battery cells and are packaged with a power storage device packaging material. Such a power storage device packaging material is required to have high shape retainability while withstanding the load of the heavy-weight battery cells, and a barrier layer with a thickness of 38 μm or more is used in the power storage device packaging material. Thus, in addition to excellent moldability, folding endurance is also required in the power storage device packaging material.

Under such circumstances, it is a main object of the present disclosure to provide a power storage device packaging material that achieves both excellent moldability and folding endurance.

### Solution to Problem

The inventors of the present disclosure have conducted extensive research to solve the aforementioned problem. As a result, they have found that both excellent moldability and folding endurance are achieved by a power storage device packaging material, which comprises a laminate comprising at least a base material layer, a barrier layer, and a heat-sealable resin layer, wherein the barrier layer has a thickness of 38 μm or more, and wherein the power storage device packaging material has a predetermined bending resistance and a predetermined number of double folds.

The present disclosure has been completed as a result of further research based on these novel findings. In summary, the present disclosure provides an aspect of the invention as set forth below:

A power storage device packaging material, comprising a laminate comprising at least a base material layer, a barrier layer, and a heat-sealable resin layer in this order from an outer side,
wherein the barrier layer has a thickness of 38 μm or more;
the laminate has a bending resistance of 1.1 mN or more, as measured under the following conditions in accordance with the provisions of JIS L1085: 1998:

### <Conditions for Measuring the Bending Resistance>

a Gurley stiffness tester is used; a sample size is 25 mm (MD)×51 mm (TD); the width of 51 mm is chucked; a weight of 25 g is used for measurement of a bending resistance of less than 2.0 mN, and a weight of 200 g is used for measurement of a bending resistance of 2.0 mN or more; five measurements are performed for each of left and right directions, at a rotation speed of 2.0 rpm; and an average of a total of 10 measured values is determined as the bending resistance; and
the number of double folds until a pinhole is formed in the laminate is 600 or more, as measured under the following conditions in accordance with the provisions of JIS P8115: 2001:

### <Conditions for Measuring the Number of Double Folds Until a Pinhole is Formed>

an MIT folding endurance tester is used, and the number of double folds until a pinhole is formed is measured under the following conditions: a sample size of 150 mm (MD)×15 mm (TD); a load of 1000 g; a folding angle of 45°; a folding speed of 175 times/min; and a chuck shape with an edge radius R of 0.38 mm.

### Advantageous Effects of Invention

According to the present disclosure, it is possible to provide a power storage device packaging material that achieves both excellent moldability and folding endurance. According to the present disclosure, it is also possible to provide a method for producing the power storage device packaging material and a power storage device using the power storage device packaging material.

### BRIEF DESCRIPTION OF DRAWINGS

FIG. 1 is a schematic diagram showing one exemplary cross-sectional structure of a power storage device packaging material of the present disclosure.

FIG. 2 is a schematic diagram showing one exemplary cross-sectional structure of a power storage device packaging material of the present disclosure.

FIG. 3 is a schematic diagram showing one exemplary cross-sectional structure of a power storage device packaging material of the present disclosure.

FIG. 4 is a schematic diagram showing one exemplary cross-sectional structure of a power storage device packaging material of the present disclosure.

FIG. 5 is a schematic diagram for illustrating a method of housing a power storage device element in a package formed of a power storage device packaging material of the present disclosure.

### DESCRIPTION OF EMBODIMENTS

A power storage device packaging material of the present disclosure comprises a laminate comprising at least a base material layer, a barrier layer, and a heat-sealable resin layer in this order from an outer side, wherein the barrier layer has a thickness of 38 μm or more, the laminate has a bending resistance of 1.1 mN or more, as measured under the below-described conditions in accordance with the provisions of JIS L1085: 1998, and the number of double folds until a pinhole is formed in the laminate is 600 or more, as measured under the below-described conditions in accordance with the provisions of JIS P8115: 2001. Because of these features, the power storage device packaging material of the present disclosure achieves both excellent moldability and folding endurance.

The power storage device packaging material of the present disclosure will be hereinafter described in detail. As used herein, any numerical range indicated by “ . . . to . . . ” is intended to mean “ . . . or more” and “ . . . or less”. For example, the recitation “2 to 15 mm” is intended to mean 2 mm or more and 15 mm or less.

### 1. Laminated Structure and Physical Properties of the Power Storage Device Packaging Material

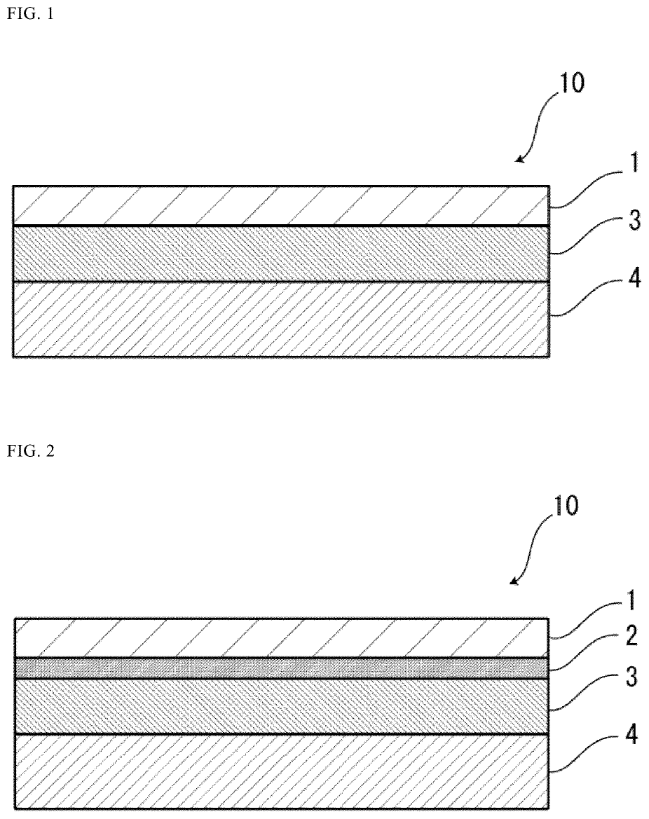

As shown in FIGS. 1 to 4, for example, a power storage device packaging material 10 of the present disclosure comprises a laminate comprising at least a base material layer 1, a barrier layer 3, and a heat-sealable resin layer 4 in this order. In the power storage device packaging material 10, the base material layer 1 is the outermost layer, and the heat-sealable resin layer 4 is the innermost layer. During the assembly of a power storage device using the power storage device packaging material 10 and a power storage device element, the power storage device element is housed in a space formed by heat-sealing peripheral regions of the opposing heat-sealable resin layers 4 of the power storage device packaging material 10. In the laminate constituting the power storage device packaging material 10 of the present disclosure, when the barrier layer 3 is used as the reference, the heat-sealable resin layer 4 side relative to the barrier layer 3 is defined as the inner side, and the base material layer 1 side relative to the barrier layer 3 is defined as the outer side.

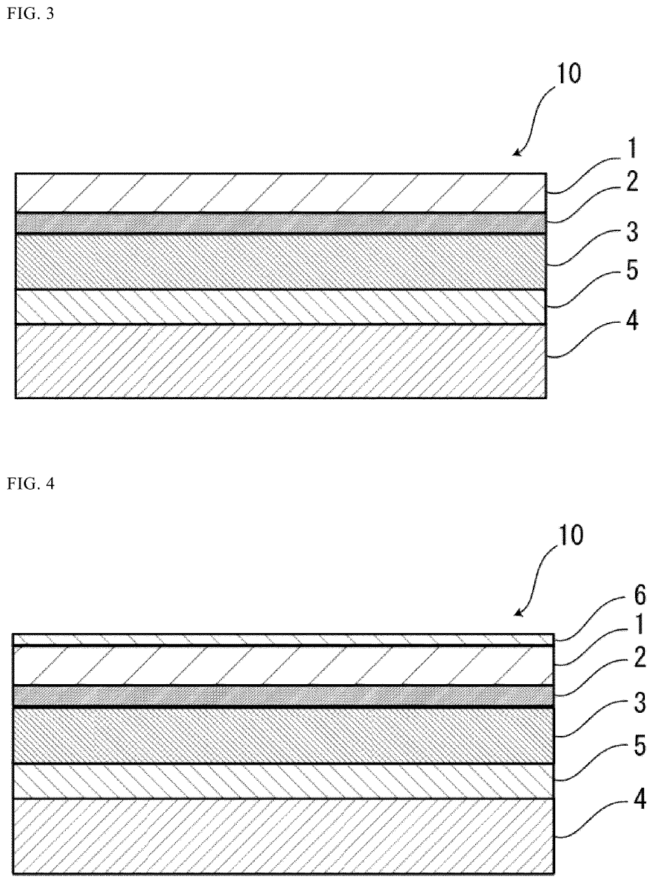

As shown in FIGS. 2 to 4, for example, the power storage device packaging material 10 may optionally have an adhesive agent layer 2 between the base material layer 1 and the barrier layer 3, for the purpose of, for example, improving the adhesiveness between these layers. Moreover, as shown in FIGS. 3 and 4, for example, the power storage device packaging material 10 may also optionally have an adhesive layer 5 between the barrier layer 3 and the heat-sealable resin layer 4, for the purpose of, for example, improving the adhesiveness between these layers. Furthermore, as shown in FIG. 4, a surface coating layer 6 or the like may be optionally provided on an outer side of the base material layer 1 (opposite to the heat-sealable resin layer 4 side).

While the thickness of the laminate constituting the power storage device packaging material 10 is not specifically limited, it is, for example, about 300 μm or less, and preferably about 250 μm or less, about 200 μm or less, or about 190 μm or less, in view of reducing costs or improving the energy density, for example. On the other hand, in view of maintaining the function of the power storage device packaging material to protect the power storage device element, the thickness of the laminate constituting the power storage device packaging material 10 is preferably, for example, about 60 μm or more, about 80 μm or more, about 100 μm or more, about 150 μm or more, or about 180 μm or more. Preferred ranges of the laminate constituting the power storage device packaging material 10 include, for example, from about 60 to 300 μm, from about 60 to 250 μm, from about 60 to 200 μm, from about 60 to 190 μm, from about 80 to 300 μm, from about 80 to 250 μm, from about 80 to 200 μm, from about 80 to 190 μm, from about 100 to 300 μm, from about 100 to 250 μm, from about 100 to 200 μm, from about 100 to 190 μm, from about 150 to 300 μm, from about 150 to 250 μm, from about 150 to 200 μm, from about 150 to 190 μm, from about 180 to 300 μm, from about 180 to 250 μm, from about 180 to 200 μm, and from about 180 to 190 μm.

In the power storage device packaging material 10, a ratio of the total thickness of the base material layer 1, the optional adhesive agent layer 2, the barrier layer 3, the optional adhesive layer 5, the heat-sealable resin layer 4, and the optional surface coating layer 6, relative to the thickness (entire thickness) of the laminate constituting the power storage device packaging material 10, is preferably 90% or more, more preferably 95% or more, and still more preferably 98% or more. As a specific example, when the power storage device packaging material 10 of the present disclosure includes the base material layer 1, the adhesive agent layer 2, the barrier layer 3, the adhesive layer 5, and the heat-sealable resin layer 4, the ratio of the total thickness of these layers relative to the thickness (entire thickness) of the laminate constituting the power storage device packaging material 10 is preferably 90% or more, more preferably 95% or more, and still more preferably 98% or more. Similarly when the power storage device packaging material 10 of the present disclosure is a laminate including the base material layer 1, the adhesive agent layer 2, the barrier layer 3, and the heat-sealable resin layer 4, the ratio of the total thickness of these layers relative to the thickness (entire thickness) of the laminate constituting the power storage device packaging material 10 may be, for example, 80% or more, preferably 90% or more, more preferably 95% or more, and still more preferably 98% or more.

The power storage device packaging material 10 of the present disclosure has a bending resistance of 1.1 mN or more, as measured under the following conditions in accordance with the provisions of JIS L1085: 1998. While JIS L1085: 1998 defines a testing method for nonwoven interlining fabrics, this method is also applied herein to materials other than nonwoven fabrics.

### <Conditions for Measuring the Bending Resistance>

A Gurley stiffness tester is used; a sample size is 25 mm (MD)×51 mm (TD); the width of 51 mm is chucked; a weight of 25 g is used for measurement of a bending resistance of less than 2.0 mN, and a weight of 200 g is used for measurement of a bending resistance of 2.0 mN or more; five measurements are performed for each of left and right directions, at a rotation speed of 2.0 rpm; and an average of a total of 10 measured values is determined as the bending resistance. Specifically, the measurement is performed first with a weight of 25 g, and if no error occurs, a total of 10 measurements are performed to calculate the bending resistance. This results in a measurement of less than 2.0 mN. Conversely, if the measurement is performed with a weight of 25 g, and the movable arm swings to the limit point and an error occurs, the weight of 25 g is replaced by a weight of 200 g, and the measurement is started again from the beginning to calculate the bending resistance. This results in a measurement of 2.0 mN or more. The sample length adjustment position and the weight position are each set to the adjustment positions specific to the testing machine. Specifically, the weight is placed in the position “c” shown in FIG. 8 in 6.10.3 of JIS L1085: 1998.

In view of more satisfactorily achieving the effects of the invention of the present disclosure, the bending resistance of the power storage device packaging material 10 is preferably about 1.5 mN or more, more preferably about 2.0 mN or more, and still more preferably about 2.5 mN or more, while the aforementioned bending resistance is preferably about 5.0 mN or less, more preferably about 4.5 mN or less, and still more preferably about 4.0 mN or less. A preferred range is, for example, from about 1.1 to 5.0 mN.

Examples of methods for increasing the bending resistance of the power storage device packaging material 10 to 1.1 mN or more include methods in which the thickness of the barrier layer, the base material layer, or the heat-sealable resin layer is increased; methods in which the proof stress value or tensile strength of the aluminum foil used as the barrier layer is increased; and methods in which the degree of crystallinity, tensile strength, or yield point strength of the base material layer or the heat-sealable resin layer is increased.

In the power storage device packaging material 10 of the present disclosure, the number of double folds until a pinhole is formed in the power storage device packaging material is 600 or more, as measured under the following conditions in accordance with the provisions of JIS P8115: 2001:

### <Conditions for Measuring the Number of Double Folds Until a Pinhole is Formed>

An MIT folding endurance tester is used, and the number of double folds until a pinhole is formed is measured under the following conditions: a sample size of 150 mm (MD)×15 mm (TD); a load of 1000 g; a folding angle of 45°; a folding speed of 175 times/min; and a chuck shape with an edge radius R of 0.38 mm.

In view of more satisfactorily achieving the effects of the invention of the present disclosure, the number of double folds until a pinhole is formed in the power storage device packaging material 10 is preferably about 700 or more, more preferably about 800 or more, and still more preferably about 900 or more, while the aforementioned number is preferably about 4000 or less, more preferably about 3500 or less, and still more preferably about 3000 or less. Preferred ranges include from about 600 to 4000, from about 600 to 3500, from about 600 to 3000, from about 700 to 4000, from about 700 to 3500, from about 700 to 3000, from about 800 to 4000, from about 800 to 3500, from about 800 to 3000, from about 900 to 4000, from about 900 to 3500, and from about 900 to 3000.

Examples of methods for increasing the number of double folds until a pinhole is formed in the power storage device packaging material 10 to 600 or more include methods in which the thickness of the barrier layer, the base material layer, or the heat-sealable resin layer is increased; methods in which the proof stress value or tensile strength of the aluminum foil used as the barrier layer is increased; and methods in which the degree of crystallinity, tensile strength, or yield point strength of the base material layer or the heat-sealable resin layer is increased.

In view of more satisfactorily achieving the effects of the invention of the present disclosure, in the power storage device packaging material 10 of the present disclosure, a ratio of tensile elastic modulus of the base material layer 1 to tensile elastic modulus of the heat-sealable resin layer 4 (tensile elastic modulus of the base material layer 1/tensile elastic modulus of the heat-sealable resin layer 4) is preferably 5.0 times or less, more preferably 4.0 times or less, and still more preferably 3.0 times or less, while the aforementioned ratio is preferably 1 time. Preferred ranges include from 1 to 5.0 times, from 1 to 4.0 times, and from 1 to 3.0 times. The closer the ratio is to 1 time, the better the balance between the tensile elastic moduli of the base material layer and the heat-sealable resin layer. This affects the above-described bending resistance and pinhole count and facilitates improving the moldability and folding endurance. The method of measuring the tensile elastic modulus of the base material layer or the heat-sealable resin layer is as set forth below.

### <Measurement of the Tensile Elastic Moduli of the Base Material Layer and the Heat-Sealable Resin Layer>

The tensile elastic modulus of the base material layer is measured in accordance with JIS K7127: 1999, using a rectangular specimen with a width of 15 mm, by pulling the specimen in the MD direction at a speed of 200 mm/min, in a measurement environment at 23° C. and 50% RH. The tensile elastic modulus of the heat-sealable resin layer is measured in accordance with JIS K7161-2:2014, by preparing a 5A dumbbell-shaped specimen and subjecting the specimen to measurement at a speed of 500 mm/min, in a measurement environment at 23° C. and 50% RH. When the base material layer or the heat-sealable resin layer is composed of a plurality of layers, the tensile elastic modulus is measured for each layer, and the value of tensile elastic modulus is calculated in terms of the thickness ratio. For example, when the base material layer is composed of two layers, with a base material A and a base material B being laminated with an adhesive, the elastic modulus of each of the base materials A and B is measured without considering the elastic modulus of the adhesive agent layer, and the elastic modulus is calculated in terms of the thickness ratio between the base materials A and B.

### 2. Layers Forming the Power Storage Device Packaging Material

### [Base Material Layer 1]

In the present disclosure, the base material layer 1 is a layer provided for the purpose of, for example, functioning as a base material of the power storage device packaging material. The base material layer 1 is positioned as the outermost layer of the power storage device packaging material.

The material forming the base material layer 1 is not specifically limited as long as it functions as a base material, i.e., has at least insulation properties. The base material layer 1 may be formed using a resin, for example, and the resin may contain additives as described below.

When the base material layer 1 is formed of a resin, the base material layer 1 may be, for example, a resin film formed of a resin or a layer formed by applying a resin. That is, when the base material layer 1 is formed of a resin, the base material layer 1 may be formed of a resin film, for example. When the base material layer 1 is formed of a resin film, a pre-formed resin film may be used as the base material layer 1 when laminating the base material layer 1 with the barrier layer 3 or the like to produce the power storage device packaging material 10 of the present disclosure. Alternatively, the resin forming the base material layer 1 may be formed into a film on a surface of the barrier layer 3 or the like by extrusion, coating, or the like, and used as the base material layer 1 formed of a resin film. The resin film may be an unstretched film or a stretched film. Examples of the stretched film include a uniaxially stretched film and a biaxially stretched film, with a biaxially stretched film being preferred. Examples of stretching methods for forming a biaxially stretched film include a sequential biaxial stretching method, an inflation method, and a simultaneous biaxial stretching method. Examples of methods of applying the resin include roll coating, gravure coating, and extrusion coating.

Examples of the resin forming the base material layer 1 include resins such as polyesters, polyamides, polyolefins, epoxy resins, acrylic resins, fluororesins, polyurethanes, silicone resins, and phenol resins, as well as modified resins thereof. The resin forming the base material layer 1 may also be a copolymer of these resins or a modified copolymer thereof. The resin forming the base material layer 1 may also be a mixture of these resins.

The base material layer 1 preferably contains these resins as a main component, and more preferably contains a polyester or a polyamide as a main component. As used herein, the term “main component” means a resin component whose content is, for example, 50% by mass or more, preferably 60% by mass or more, more preferably 70% by mass or more, still more preferably 80% by mass or more, even more preferably 90% by mass or more, still more preferably 95% by mass or more, even more preferably 98% by mass or more, and still more preferably 99% by mass or more, among the resin components contained in the base material layer 1. For example, the phrase “the base material layer 1 contains a polyester or a polyamide as a main component” means that the polyester or polyamide content is, for example, 50% by mass or more, preferably 60% by mass or more, more preferably 70% by mass or more, still more preferably 80% by mass or more, even more preferably 90% by mass or more, still more preferably 95% by mass or more, even more preferably 98% by mass or more, and still more preferably 99% by mass or more, among the resin components contained in the base material layer 1.

Among these, the resin forming the base material layer 1 is preferably a polyester or a polyamide.

Specific examples of polyesters include polyethylene terephthalate, polybutylene terephthalate, polyethylene naphthalate, polybutylene naphthalate, polyethylene isophthalate, and copolyesters. Examples of copolyesters include copolyesters containing ethylene terephthalate as a main repeating unit. Specific examples of these copolyesters include copolyesters obtained by polymerizing ethylene terephthalate as a main repeating unit with ethylene isophthalate (abbreviated as polyethylene (terephthalate/isophthalate); hereinafter similarly abbreviated), polyethylene (terephthalate/adipate), polyethylene (terephthalate/sodium sulfoisophthalate), polyethylene (terephthalate/sodium isophthalate), polyethylene (terephthalate/phenyl-dicarboxylate), and polyethylene (terephthalate/decane dicarboxylate). These polyesters may be used alone or in combination.

Specific examples of polyamides include aliphatic polyamides, such as nylon 6, nylon 66, nylon 610, nylon 12, nylon 46, and copolymers of nylon 6 and nylon 66; hexamethylenediamine-isophthalic acid-terephthalic acid copolyamides containing structural units derived from terephthalic acid and/or isophthalic acid, for example, nylon 61, nylon 6T, nylon 6IT, and nylon 616T (I denotes isophthalic acid, and T denotes terephthalic acid), and polyamides containing aromatics, such as polyamide MXD6 (polymethaxylylene adipamide); cycloaliphatic polyamides, such as polyamide PACM6 (polybis(4-aminocyclohexyl) methane adipamide); polyamides copolymerized with a lactam component or an isocyanate component such as 4,4′-diphenylmethane-diisocyanate, and polyester amide copolymers or polyether ester amide copolymers that are copolymers of copolyamides with polyesters or polyalkylene ether glycols; and copolymers thereof. These polyamides may be used alone or in combination.

The base material layer 1 preferably contains at least one of a polyester film, a polyamide film, and a polyolefin film, preferably contains at least one of a stretched polyester film, a stretched polyamide film, and a stretched polyolefin film, more preferably contains at least one of a stretched polyethylene terephthalate film, a stretched polybutylene terephthalate film, a stretched nylon film, and a stretched polypropylene film, and more preferably contains at least one of a biaxially stretched polyethylene terephthalate film, a biaxially stretched polybutylene terephthalate film, a biaxially stretched nylon film, and a biaxially stretched polypropylene film.

The base material layer 1 may be a single layer, or may be composed of two or more layers. When the base material layer 1 is composed of two or more layers, the base material layer 1 may be a laminate in which resin films are laminated with an adhesive or the like, or may be a laminate of two or more layers of resin films formed by co-extruding resins. The laminate of two or more layers of resin films formed by co-extruding resins may be used in an unstretched state as the base material layer 1, or may be uniaxially or biaxially stretched and used as the base material layer 1.

Specific examples of laminates of two or more layers of resin films in the base material layer 1 include a laminate of a polyester film and a nylon film, a laminate of two or more layers of nylon films, and a laminate of two or more layers of polyester films. Preferred are a laminate of a stretched nylon film and a stretched polyester film, a laminate of two or more layers of stretched nylon films, and a laminate of two or more layers of stretched polyester films. For example, when the base material layer 1 is a laminate of two layers of resin films, it is preferably a laminate of a polyester resin film and a polyester resin film, a laminate of a polyamide resin film and a polyamide resin film, or a laminate of a polyester resin film and a polyamide resin film, and more preferably a laminate of a polyethylene terephthalate film and a polyethylene terephthalate film, a laminate of a nylon film and a nylon film, or a laminate of a polyethylene terephthalate film and a nylon film. When the base material layer 1 is a laminate of two or more layers of resin films, the polyester resin film is preferably positioned as the outermost layer of the base material layer 1, because the polyester resin is resistant to discoloration when, for example, the electrolytic solution adheres to the surface.

When the base material layer 1 is a laminate of two or more layers of resin films, the two or more layers of resin films may be laminated via an adhesive. Examples of preferred adhesives are the same adhesives as those mentioned for the adhesive agent layer 2 described below. The method of laminating two or more layers of resin films is not specifically limited and may be any of known methods, for example, dry lamination, sandwich lamination, extrusion lamination, and thermal lamination, preferably dry lamination. When the lamination is performed by dry lamination, a polyurethane adhesive is preferably used as an adhesive. In this case, the thickness of the adhesive is, for example, about 2 to 5 μm. Alternatively, the resin films may be coated with an anchor coat layer and laminated. Examples of the anchor coat layer are the same adhesives as those mentioned for the adhesive agent layer 2 described below. In this case, the thickness of the anchor coat layer is, for example, about 0.01 to 1.0 μm.

Additives such as lubricants, flame retardants, anti-blocking agents, antioxidants, light stabilizers, tackifiers, and anti-static agents may be present on at least one of the surface and the inside of the base material layer 1. A single additive may be used alone, or a mixture of two or more additives may be used.

In the present disclosure, preferably, a lubricant is present on at least one of the surface and the inside of the base material layer 1, in view of improving the moldability of the power storage device packaging material. While the lubricant is not specifically limited, it is preferably an amide-based lubricant. Specific examples of amide-based lubricants include saturated fatty acid amides, unsaturated fatty acid amides, substituted amides, methylol amides, saturated fatty acid bis-amides, unsaturated fatty acid bis-amides, fatty acid ester amides, and aromatic bis-amides. Specific examples of saturated fatty acid amides include lauramide, palmitamide, stearamide, behenamide, and hydroxystearamide. Specific examples of unsaturated fatty acid amides include oleamide and erucamide. Specific examples of substituted amides include N-oleyl palmitamide, N-stearyl stearamide, N-stearyl oleamide, N-oleyl stearamide, and N-stearyl erucamide. Specific examples of methylol amides include methylol stearamide. Specific examples of saturated fatty acid bis-amides include methylene-bis-stearamide, ethylene-bis-capramide, ethylene-bis-lauramide, ethylene-bis-stearamide, ethylene-bis-hydroxystearamide, ethylene-bis-behenamide, hexamethylene-bis-stearamide, hexamethylene-bis-behenamide, hexamethylene hydroxystearamide, N,N′-distearyl adipamide, and N,N′-distearyl sebacamide. Specific examples of unsaturated fatty acid bis-amides include ethylene-bis-oleamide, ethylene-bis-erucamide, hexamethylene-bis-oleamide, N,N′-dioleyl adipamide, and N,N′-dioleyl sebacamide. Specific examples of fatty acid ester amides include stearamide ethyl stearate. Specific examples of aromatic bis-amides include m-xylylene-bis-stearamide, m-xylylene-bis-hydroxystearamide, and N,N′-distearyl isophthalamide. A single lubricant may be used alone, or a combination of two or more lubricants may be used, with a combination of two or more lubricants being preferred.

When a lubricant is present on the surface of the base material layer 1, the amount of the lubricant present is not specifically limited but is, for example, about 3 mg/m² or more, preferably about 4 mg/m² or more, and more preferably about 5 mg/m² or more. On the other hand, the amount of the lubricant present on the surface of the base material layer 1 is, for example, about 15 mg/m² or less, preferably about 14 mg/m² or less, or about 10 mg/m² or less. Preferred ranges of the amount of the lubricant present on the surface of the base material layer 1 include from about 3 to 15 mg/m², from about 3 to 14 mg/m², from about 3 to 10 mg/m², from about 4 to 15 mg/m², from about 4 to 14 mg/m², from about 4 to 10 mg/m², from about 5 to 15 mg/m², from about 5 to 14 mg/m², and from about 5 to 10 mg/m².

The lubricant present on the surface of the base material layer 1 may be exuded from the lubricant contained in the resin forming the base material layer 1, or may be applied to the surface of the base material layer 1.

While the thickness of the base material layer 1 is not specifically limited as long as the function as a base material is exhibited, the thickness is, for example, about 3 μm or more, and preferably about 10 μm or more. On the other hand, the thickness of the base material layer 1 is, for example, about 50 μm or less, and preferably about 35 μm or less. Preferred ranges of the thickness of the base material layer 1 include from about 3 to 50 μm, from about 3 to 35 μm, from about 10 to 50 μm, and from about 10 to 35 μm. In particular, the range of about 3 to 35 μm is preferred in order to make the power storage device lighter weight and smaller in thickness, while the range of about 35 to 50 μm is preferred in order to improve moldability. When the base material layer 1 is a laminate of two or more layers of resin films, the thickness of the resin film constituting each layer is not specifically limited but is, for example, about 2 μm or more, preferably about 10 μm or more, or about 18 μm or more. On the other hand, the thickness of the resin film constituting each layer is, for example, about 33 μm or less, preferably about 28 μm or less, about 23 μm or less, or about 18 μm or less. Preferred ranges of the thickness of the resin film constituting each layer include from about 2 to 33 μm, from about 2 to 28 μm, from about 2 to 23 μm, from about 2 to 18 μm, from about 10 to 33 μm, from about 10 to 28 μm, from about 10 to 23 μm, from about 10 to 18 μm, from about 18 to 33 μm, from about 18 to 28 μm, and from about 18 to 23 μm.

### [Adhesive Agent Layer 2]

In the power storage device packaging material of the present disclosure, the adhesive agent layer 2 is a layer that is optionally provided between the base material layer 1 and the barrier layer 3, for the purpose of improving the adhesiveness between these layers.

The adhesive agent layer 2 is formed of an adhesive capable of bonding the base material layer 1 and the barrier layer 3. While the adhesive used for forming the adhesive agent layer 2 is not limited, it may be any of a chemical reaction type, a solvent volatilization type, a heat melting type, a heat pressing type, and the like. The adhesive may also be a two-component curable adhesive (two-component adhesive), a one-component curable adhesive (one-component adhesive), or a resin that does not involve a curing reaction. The adhesive agent layer 2 may be composed of a single layer or a plurality of layers.

Specific examples of adhesive components contained in the adhesive include polyesters, such as polyethylene terephthalate, polybutylene terephthalate, polyethylene naphthalate, polybutylene naphthalate, polyethylene isophthalate, and copolyesters; polyethers; polyurethanes; epoxy resins; phenol resins; polyamides, such as nylon 6, nylon 66, nylon 12, and copolyamides; polyolefin resins, such as polyolefins, cyclic polyolefins, acid-modified polyolefins, and acid-modified cyclic polyolefins; polyvinyl acetates; celluloses; (meth)acrylic resins; polyimides; polycarbonates; amino resins, such as urea resins and melamine resins; rubbers, such as chloroprene rubber, nitrile rubber, and styrene-butadiene rubber; and silicone resins. These adhesive components may be used alone or in combination. Preferred among these adhesive components is a polyurethane adhesive, for example. Moreover, the resin that serves as the adhesive component can be used in combination with an appropriate curing agent to improve the adhesive strength. The curing agent is appropriately selected from a polyisocyanate, a polyfunctional epoxy resin, an oxazoline group-containing polymer, a polyamine resin, an acid anhydride, and the like, according to the functional group of the adhesive component.

The polyurethane adhesive may be, for example, a polyurethane adhesive that contains a first agent containing a polyol compound and a second agent containing an isocyanate compound. The polyurethane adhesive is preferably a two-component curable polyurethane adhesive containing a polyol such as a polyester polyol, a polyether polyol, or an acrylic polyol as the first agent, and an aromatic or aliphatic polyisocyanate as the second agent. The polyurethane adhesive may also be, for example, a polyurethane adhesive that contains a polyurethane compound obtained beforehand by reacting a polyol compound and an isocyanate compound, and an isocyanate compound. The polyurethane adhesive may also be, for example, a polyurethane adhesive that contains a polyurethane compound obtained beforehand by reacting a polyol compound and an isocyanate compound, and a polyol compound. The polyurethane adhesive may also be, for example, a polyurethane adhesive produced by curing a polyurethane compound obtained beforehand by reacting a polyol compound and an isocyanate compound, by reacting with moisture such as moisture in the air. The polyol compound is preferably a polyester polyol having a hydroxy group at a side chain, in addition to the hydroxy groups at the ends of the repeating unit. Examples of the second agent include aliphatic, alicyclic, aromatic, and aromatic and aliphatic isocyanate compounds. Examples of isocyanate compounds include hexamethylene diisocyanate (HDI), xylylene diisocyanate (XDI), isophorone diisocyanate (IPDI), hydrogenated XDI (H6XDI), hydrogenated MDI (H12MDI), tolylene diisocyanate (TDI), diphenylmethane diisocyanate (MDI), and naphthalene diisocyanate (NDI). Examples also include modified polyfunctional isocyanates obtained from one, or two or more of these diisocyanates. A multimer (for example, a trimer) may also be used as a polyisocyanate compound. Examples of such multimers include adducts, biurets, and isocyanurates. When the adhesive agent layer 2 is formed of a polyurethane adhesive, the power storage device packaging material is provided with excellent electrolytic solution resistance, which prevents the base material layer 1 from peeling off even if the electrolytic solution adheres to the side surface.

The adhesive agent layer 2 may be blended with other components as long as they do not interfere with adhesiveness, and may contain colorants, thermoplastic elastomers, tackifiers, fillers, and the like. When the adhesive agent layer 2 contains a colorant, the power storage device packaging material can be colored. The colorant may be any of known colorants, such as a pigment or a dye. A single colorant may be used, or a mixture of two or more colorants may be used.

The type of pigment is not specifically limited as long as it does not interfere with the adhesiveness of the adhesive agent layer 2. Examples of organic pigments include azo-based, phthalocyanine-based, quinacridone-based, anthraquinone-based, dioxazine-based, indigo/thioindigo-based, perinone-perylene-based, isoindolenine-based, and benzimidazolone-based pigments. Examples of inorganic pigments include carbon black-based, titanium oxide-based, cadmium-based, lead-based, chromium oxide-based, and iron-based pigments. Other examples include mica powder and fish scale flakes.

Among these colorants, carbon black is preferred, in order to make the external appearance of the power storage device packaging material black, for example.

The average particle diameter of the pigment is not specifically limited and may be, for example, about 0.05 to 5 μm, and preferably about 0.08 to 2 μm. The average particle diameter of the pigment is the median diameter as measured using a laser diffraction/scattering particle size distribution analyzer.

The pigment content in the adhesive agent layer 2 is not specifically limited as long as the power storage device packaging material is colored; for example, it is about 5 to 60% by mass, and preferably 10 to 40% by mass.

While the thickness of the adhesive agent layer 2 is not specifically limited as long as the base material layer 1 and the barrier layer 3 can be bonded, it is, for example, about 1 μm or more or about 2 μm or more. On the other hand, the thickness of the adhesive agent layer 2 is, for example, about 10 μm or less or about 5 μm or less. Preferred ranges of the thickness of the adhesive agent layer 2 include from about 1 to 10 μm, from about 1 to 5 μm, from about 2 to 10 μm, and from about 2 to 5 μm.

### [Barrier Layer 3]

In the power storage device packaging material, the barrier layer 3 is a layer that at least prevents the ingress of moisture.

The barrier layer 3 may be, for example, a metal foil, a vapor-deposited film, or a resin layer having barrier properties. Examples of the vapor-deposited film include a vapor-deposited metal film, a vapor-deposited inorganic oxide film, and a vapor-deposited carbon-containing inorganic oxide film. Examples of the resin layer include fluorine-containing resins, such as polyvinylidene chloride, polymers containing chlorotrifluoroethylene (CTFE) as a main component, polymers containing tetrafluoroethylene (TFE) as a main component, polymers with fluoroalkyl groups, and polymers with fluoroalkyl units as a main component; and ethylene-vinyl alcohol copolymers. The barrier layer 3 may also be, for example, a resin film having at least one of these vapor-deposited films and resin layers. A plurality of barrier layers 3 may be provided. The barrier layer 3 preferably includes a layer formed of a metal material. Specific examples of the metal material constituting the barrier layer 3 include aluminum alloys, stainless steel, titanium steel, and steel sheets. When the barrier layer 3 is a metal foil, it preferably contains at least one of an aluminum alloy foil and a stainless steel foil.

The aluminum alloy foil is more preferably a soft aluminum alloy foil formed of an annealed aluminum alloy, for example, in view of improving the moldability of the power storage device packaging material, and is more preferably an aluminum alloy foil containing iron, in view of further improving the moldability. In the aluminum alloy foil (100% by mass) containing iron, the iron content is preferably 0.1 to 9.0% by mass, and more preferably 0.5 to 2.0% by mass. When the iron content is 0.1% by mass or more, the power storage device packaging material can be provided with superior moldability. When the iron content is 9.0% by mass or less, the power storage device packaging material can be provided with superior flexibility. Examples of soft aluminum alloy foils include aluminum alloy foils having the compositions as defined in JIS H4160: 1994 A8021 H-O, JIS H4160: 1994 A8079 H-O, JIS H4000: 2014 A8021 P-O, and JIS H4000: 2014 A8079 P-O. These aluminum alloy foils may be optionally blended with silicon, magnesium, copper, manganese, and the like. The softening may be performed by annealing, for example.

Examples of the stainless steel foil include austenitic, ferritic, austenitic-ferritic, martensitic, and precipitation-hardening stainless steel foils. The stainless steel foil is preferably formed of an austenitic stainless steel, in view of providing the power storage device packaging material with superior moldability.

Specific examples of the austenitic stainless steel constituting the stainless steel foil include SUS304, SUS301, and SUS316L, with SUS304 being particularly preferred among the above.

The barrier layer 3 may have a thickness sufficient to exhibit at least the function of the barrier layer to prevent the ingress of moisture, and the thickness is not specifically limited as long as it is 38 μm or more. The thickness of the barrier layer 3 is preferably about 40 μm or more, more preferably about 45 μm or more, still more preferably about 50 μm or more, and even more preferably about 55 μm or more, while the thickness is preferably about 200 μm or less, more preferably about 150 μm or less, still more preferably about 100 μm or less, and even more preferably about 65 μm or less. Preferred ranges include from about 38 to 200 μm, from about 38 to 150 μm, from about 38 to 100 μm, from about 38 to 65 μm, from about 40 to 200 μm, from about 40 to 150 μm, from about 40 to 100 μm, from about 40 to 65 μm, from about 45 to 200 μm, from about 45 to 150 μm, from about 45 to 100 μm, from about 45 to 65 μm, from about 50 to 200 μm, from about 50 to 150 μm, from about 50 to 100 μm, from about 50 to 65 μm, from about 55 to 200 μm, from about 55 to 150 μm, from about 55 to 100 μm, and from about 55 to 65 μm.

When the barrier layer 3 is a metal foil, the barrier layer 3 preferably has a corrosion-resistant film at least on a surface opposite to the base material layer, in order to prevent dissolution or corrosion, for example. The barrier layer 3 may have corrosion-resistant films on both surfaces. As used herein, the term “corrosion-resistant film” refers to, for example, a thin film that is formed by subjecting a surface of the barrier layer to, for example, hydrothermal conversion treatment such as boehmite treatment, chemical conversion treatment, anodic oxidation treatment, plating treatment with nickel, chromium, or the like, or anti-corrosion treatment of applying a coating preparation, in order to impart corrosion resistance (for example, acid resistance and alkali resistance) to the barrier layer. Specifically, “corrosion-resistant film” means a film for improving the acid resistance of the barrier layer (acid-resistant film), a film for improving the alkali resistance of the barrier layer (alkali-resistant film), and the like. The treatments for forming the corrosion-resistant film may be performed alone or in combination. The corrosion-resistant film may be composed of a plurality of layers instead of a single layer. Among these treatments, the hydrothermal conversion treatment and the anodic oxidation treatment are treatments in which the surface of the metal foil is dissolved with a treatment agent to form a metal compound with excellent corrosion resistance. These treatments may be included in the definition of the chemical conversion treatment. When the barrier layer 3 has a corrosion-resistant film, the corrosion-resistant film is included in the barrier layer 3.

The corrosion-resistant film exhibits the effect of preventing delamination between the barrier layer (for example, an aluminum alloy foil) and the base material layer during molding of the power storage device packaging material, preventing dissolution or corrosion of the barrier layer surface, particularly dissolution or corrosion of aluminum oxide present on the barrier layer surface when the barrier layer is an aluminum alloy foil, due to hydrogen fluoride produced by the reaction between the electrolyte and moisture, and improving the adhesiveness (wettability) of the barrier layer surface to prevent delamination between the base material layer and the barrier layer during heat-sealing and prevent delamination between the base material layer and the barrier layer during molding.

Various corrosion-resistant films formed by the chemical conversion treatment are known, and typical examples include a corrosion-resistant film containing at least one of phosphates, chromates, fluorides, triazine-thiol compounds, and rare earth oxides. Examples of the chemical conversion treatment using phosphates and chromates include chromic acid chromate treatment, phosphoric acid chromate treatment, phosphate-chromate treatment, and chromate treatment. Examples of chromium compounds used in these treatments include chromium nitrate, chromium fluoride, chromium sulfate, chromium acetate, chromium oxalate, chromium biphosphate, acetylacetate chromate, chromium chloride, and chromium potassium sulfate. Examples of phosphorus compounds used in these treatments include sodium phosphate, potassium phosphate, ammonium phosphate, and polyphosphoric acid. Moreover, examples of chromate treatment include etching chromate treatment, electrolytic chromate treatment, and coating-type chromate treatment, with coating-type chromate treatment being preferred. Coating-type chromate treatment is performed as follows: Initially, at least the inner layer-side surface of the barrier layer (for example, an aluminum alloy foil) is subjected to degreasing treatment, using a well-known treatment method such as an alkali immersion method, an electrolytic cleaning method, an acid cleaning method, an electrolytic acid cleaning method, or an acid activation method. Then, a treatment solution containing, as a main component, a phosphoric acid metal salt such as Cr (chromium) phosphate, Ti (titanium) phosphate, Zr (zirconium) phosphate, or Zn (zinc) phosphate, or a mixture of these metal salts, or a treatment solution containing, as a main component, a phosphoric acid non-metal salt or a mixture of such non-metal salts, or a treatment solution containing a mixture of any of the above with a synthetic resin or the like, is applied to the degreasing treatment surface, using a well-known coating method such as roll coating, gravure printing, or dipping, and dried. The treatment solution may be formed using any of various solvents, such as, for example, water, alcohol solvents, hydrocarbon solvents, ketone solvents, ester solvents, and ether solvents, with water being preferred. The resin component to be used here may be, for example, a polymer such as a phenolic resin or an acrylic resin, and chromate treatment using an aminated phenol polymer having any of the repeating units represented by general formulae (1) to (4) shown below may be employed, for example. The aminated phenol polymer may contain one of or any combination of two or more of the repeating units represented by general formulae (1) to (4). The acrylic resin is preferably polyacrylic acid, an acrylic acid-methacrylic acid ester copolymer, an acrylic acid-maleic acid copolymer, an acrylic acid-styrene copolymer, or a derivative thereof, such as a sodium, ammonium, or amine salt. In particular, the acrylic resin is preferably a derivative of polyacrylic acid, such as an ammonium, sodium, or amine salt of polyacrylic acid. As used herein, the term “polyacrylic acid” refers to a polymer of acrylic acid. Alternatively, the acrylic resin is preferably a copolymer of acrylic acid with a dicarboxylic acid or a dicarboxylic anhydride, or preferably an ammonium, sodium, or amine salt of the copolymer of acrylic acid with a dicarboxylic acid or a dicarboxylic anhydride. A single acrylic resin may be used alone, or a mixture of two or more of acrylic resins may be used.

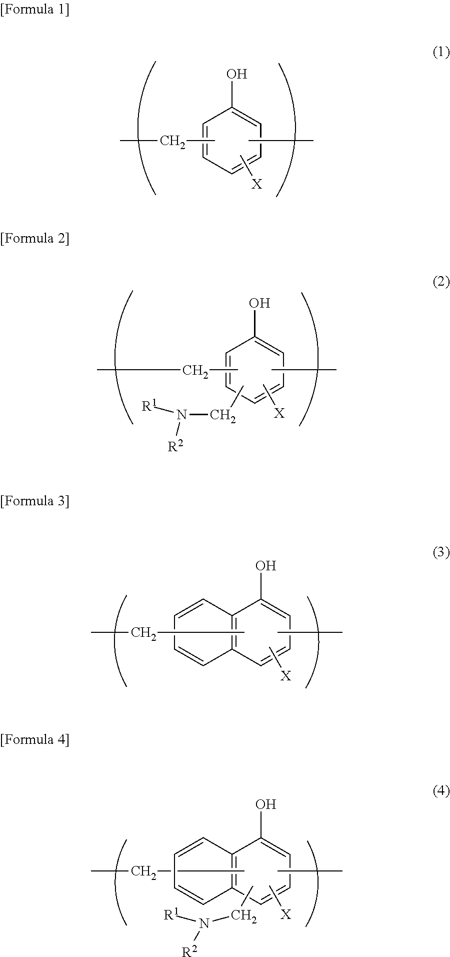

In general formulae (1) to (4), X represents a hydrogen atom, a hydroxy group, an alkyl group, a hydroxyalkyl group, an allyl group, or a benzyl group. R¹ and R² are the same or different, and each represent a hydroxy group, an alkyl group, or a hydroxyalkyl group. In general formulae (1) to (4), examples of alkyl groups represented by X, R¹, and R² include linear or branched alkyl groups with 1 to 4 carbon atoms, such as methyl, ethyl, n-propyl, isopropyl, n-butyl, isobutyl, and tert-butyl groups. Examples of hydroxyalkyl groups represented by X, R¹, and R² include linear or branched alkyl groups with 1 to 4 carbon atoms, which are substituted with one hydroxy group, such as a hydroxymethyl, 1-hydroxyethyl, 2-hydroxyethyl, 1-hydroxypropyl, 2-hydroxypropyl, 3-hydroxypropyl, 1-hydroxybutyl, 2-hydroxybutyl, 3-hydroxybutyl, or 4-hydroxybutyl group. In general formulae (1) to (4), the alkyl groups and the hydroxyalkyl groups represented by X, R¹, and R² may be the same or different. In general formulae (1) to (4), X is preferably a hydrogen atom, a hydroxy group, or a hydroxyalkyl group. The number average molecular weight of the aminated phenol polymer having any of the repeating units represented by general formulae (1) to (4) is, for example, about 500 to 1,000,000, preferably about 1,000 to 20,000. The aminated phenol polymer is produced, for example, by polycondensing a phenol compound or a naphthol compound with formaldehyde to produce a polymer composed of the repeating unit represented by general formula (1) or (3) above, and then introducing a functional group (—CH₂NR¹R²) into the polymer obtained above using formaldehyde and an amine (R¹R²NH). A single aminated phenol polymer may be used alone, or a mixture of two or more aminated phenol polymers may be used.

Other examples of the corrosion-resistant film include a thin film formed by coating-type anti-corrosion treatment in which a coating preparation containing at least one selected from the group consisting of a rare earth element oxide sol, an anionic polymer, and a cationic polymer is applied. The coating preparation may also contain phosphoric acid or a phosphate and a crosslinking agent that crosslinks the polymer. In the rare earth element oxide sol, fine particles of a rare earth element oxide (for example, particles with an average particle diameter of 100 nm or less) are dispersed in a liquid dispersion medium. Examples of the rare earth element oxide include cerium oxide, yttrium oxide, neodymium oxide, and lanthanum oxide, with cerium oxide being preferred in view of further improving the adhesion. A single rare earth element oxide or a combination of two or more rare earth element oxides may be contained in the corrosion-resistant film. The liquid dispersion medium of the rare earth element oxide sol may be any of various solvents, such as, for example, water, alcohol solvents, hydrocarbon solvents, ketone solvents, ester solvents, and ether solvents, with water being preferred. Examples of the cationic polymer include polyethyleneimine, ion polymer complexes composed of polymers containing polyethyleneimine and carboxylic acids, primary amine-grafted acrylic resins obtained by grafting primary amines to an acrylic backbone, polyallylamine or derivatives thereof, and aminated phenols. The anionic polymer is preferably a copolymer that contains, as a main component, poly(meth)acrylic acid or a salt thereof, or (meth)acrylic acid or a salt thereof. The crosslinking agent is preferably at least one selected from the group consisting of compounds with any of an isocyanate group, a glycidyl group, a carboxyl group, and an oxazoline group as a functional group, and silane coupling agents. The phosphoric acid or phosphate is preferably condensed phosphoric acid or a condensed phosphate.

One exemplary corrosion-resistant film is formed by coating the surface of the barrier layer with a dispersion in phosphoric acid of fine particles of a metal oxide, such as aluminum oxide, titanium oxide, cerium oxide, or tin oxide, or barium sulfate, and baking at 150° C. or more.

The corrosion-resistant film may optionally have a laminated structure in which at least one of a cationic polymer and an anionic polymer is additionally laminated. Examples of the cationic polymer and the anionic polymer are those as mentioned above.

The composition of the corrosion-resistant film can be analyzed using, for example, time-of-flight secondary ion mass spectrometry.

The amount of the corrosion-resistant film to be formed on the surface of the barrier layer 3 by the chemical conversion treatment is not specifically limited; for example, in the case of employing coating-type chromate treatment, it is preferred that the chromic acid compound is contained in an amount of about 0.5 to 50 mg, for example, preferably about 1.0 to 40 mg, calculated as chromium, the phosphorus compound is contained in an amount of about 0.5 to 50 mg, for example, preferably about 1.0 to 40 mg, calculated as phosphorus, and the aminated phenol polymer is contained in an amount of about 1.0 to 200 mg, for example, preferably about 5.0 to 150 mg, per m² of the surface of the barrier layer 3.

While the thickness of the corrosion-resistant film is not specifically limited, it is preferably about 1 nm to 20 μm, more preferably about 1 to 100 nm, and still more preferably about 1 to 50 nm, in view of the cohesive force of the film, and the adhesion force between the barrier layer and the heat-sealable resin layer. The thickness of the corrosion-resistant film can be measured by observation with a transmission electron microscope, or a combination of observation with a transmission electron microscope and energy dispersive X-ray spectroscopy or electron energy loss spectroscopy. As a result of the analysis of the composition of the corrosion-resistant film using time-of-flight secondary ion mass spectrometry, a peak derived from, for example, secondary ions of Ce, P, and O (for example, at least one of Ce₂PO₄⁺, CePO₄⁻, and the like) or a peak derived from, for example, secondary ions of Cr, P, and O (for example, at least one of CrPO₂⁻, CrPO₄⁻, and the like) is detected.

The chemical conversion treatment is performed by applying the solution containing the compound to be used for forming the corrosion-resistant film to a surface of the barrier layer, by bar coating, roll coating, gravure coating, dipping, or the like, followed by heating such that the temperature of the barrier layer is increased to about 70 to 200° C. Before the barrier layer is subjected to the chemical conversion treatment, the barrier layer may be subjected to the degreasing treatment using an alkali immersion method, an electrolytic cleaning method, an acid cleaning method, an electrolytic acid cleaning method, or the like. The degreasing treatment allows the chemical conversion treatment of the surface of the barrier layer to be more efficiently performed. Alternatively, by using an acid degreasing agent in which a fluorine-containing compound is dissolved in an inorganic acid in the degreasing treatment, it is possible to achieve not only the effect of degreasing the metal foil, but also to form a passive metal fluoride. In this case, only the degreasing treatment may be performed.

### [Heat-Sealable Resin Layer 4]

In the power storage device packaging material of the present disclosure, the heat-sealable resin layer 4 corresponds to the innermost layer and is a layer (sealant layer) that is heat-sealed to another heat-sealable resin layer during the assembly of a power storage device to exhibit the function of hermetically sealing the power storage device element.

While the resin constituting the heat-sealable resin layer 4 is not specifically limited as long as it is heat-sealable, examples include resins containing a polyolefin backbone, such as a polyolefin and an acid-modified polyolefin. The inclusion of the polyolefin backbone in the resin constituting the heat-sealable resin layer 4 can be analyzed by, for example, infrared spectroscopy or gas chromatography-mass spectrometry. It is preferred that when the resin constituting the heat-sealable resin layer 4 is analyzed by infrared spectroscopy, a peak derived from maleic anhydride is detected. For example, when a maleic anhydride-modified polyolefin is measured by infrared spectroscopy, peaks derived from maleic anhydride are detected at a wavelength near 1760 cm⁻¹ and a wavelength near 1780 cm⁻¹. When the heat-sealable resin layer 4 is a layer formed of a maleic anhydride-modified polyolefin, the peaks derived from maleic anhydride are detected in infrared spectroscopic measurement. However, if the degree of acid modification is low, the peaks may be so small that they cannot be detected. In that case, the analysis can be performed by nuclear magnetic resonance spectroscopy.

Specific examples of the polyolefin include polyethylenes, such as low-density polyethylene, medium-density polyethylene, high-density polyethylene, and linear low-density polyethylene; ethylene-α-olefin copolymers; polypropylenes, such as homopolypropylene, block copolymers of polypropylene (for example, block copolymers of propylene and ethylene), and random copolymers of polypropylene (for example, random copolymers of propylene and ethylene); propylene-α-olefin copolymers; and terpolymers of ethylene-butene-propylene. Among the above, polypropylenes are preferred. When the polyolefin resin is a copolymer, it may be a block copolymer or a random copolymer. These polyolefin resins may be used alone or in combination.

The polyolefin may also be a cyclic polyolefin. The cyclic polyolefin is a copolymer of an olefin with a cyclic monomer. Examples of the olefin as a constituent monomer of the cyclic polyolefin include ethylene, propylene, 4-methyl-1-pentene, styrene, butadiene, and isoprene. Examples of the cyclic monomer as a constituent monomer of the cyclic polyolefin include cyclic alkenes, such as norbornene; and cyclic dienes, such as cyclopentadiene, dicyclopentadiene, cyclohexadiene, and norbornadiene. Among the above, cyclic alkenes are preferred, and norbornene is more preferred.

The acid-modified polyolefin is a polymer obtained by modifying the polyolefin by block polymerization or graft polymerization with an acid component. The polyolefin to be acid-modified may, for example, be the above-mentioned polyolefin, or a copolymer obtained by copolymerizing the above-mentioned polyolefin with a polar molecule, such as acrylic acid or methacrylic acid, or a polymer such as a crosslinked polyolefin. Examples of the acid component to be used for the acid modification include carboxylic acids and anhydrides thereof, such as maleic acid, acrylic acid, itaconic acid, crotonic acid, maleic anhydride, and itaconic anhydride.

The acid-modified polyolefin may also be an acid-modified cyclic polyolefin. The acid-modified cyclic polyolefin is a polymer obtained by replacing a portion of the monomers constituting the cyclic polyolefin with an acid component and copolymerizing them, or by block-polymerizing or graft-polymerizing an acid component onto the cyclic polyolefin. The cyclic polyolefin to be acid-modified is the same as described above. The acid component used for the acid modification is the same as that used for the modification of the above-mentioned polyolefin.

Examples of preferred acid-modified polyolefins include polyolefins modified with carboxylic acids or anhydrides thereof, polypropylenes modified with carboxylic acids or anhydrides thereof, maleic anhydride-modified polyolefins, and maleic anhydride-modified polypropylenes.

The heat-sealable resin layer 4 may be formed of a single resin alone, or may be formed of a blend polymer obtained by combining two or more resins. Furthermore, the heat-sealable resin layer 4 may be formed of only one layer, or may be formed of two or more layers using the same resin or different resins.

The heat-sealable resin layer 4 may also optionally contain a lubricant and the like. The inclusion of a lubricant in the heat-sealable resin layer 4 can improve the moldability of the power storage device packaging material. The lubricant is not specifically limited and may be a known lubricant. Such lubricants may be used alone or in combination.

While the lubricant is not specifically limited, it is preferably an amide-based lubricant. Specific examples of the lubricant are those mentioned for the base material layer 1. Such lubricants may be used alone or in combination.

When a lubricant is present on the surface of the heat-sealable resin layer 4, the amount of the lubricant present is not specifically limited, but is preferably about 10 to 50 mg/m², and more preferably about 15 to 40 mg/m², in view of improving the moldability of the power storage device packaging material.

The lubricant present on the surface of the heat-sealable resin layer 4 may be exuded from the lubricant contained in the resin constituting the heat-sealable resin layer 4, or may be applied to the surface of the heat-sealable resin layer 4.

The thickness of the heat-sealable resin layer 4 is not specifically limited as long as the heat-sealable resin layer is heat-sealed to another heat-sealable resin layer to exhibit the function of hermetically sealing the power storage device element; for example, the thickness is about 100 μm or less, preferably about 85 μm or less, and more preferably about 15 to 85 μm. For example, when the thickness of the below-described adhesive layer 5 is 10 μm or more, the thickness of the heat-sealable resin layer 4 is preferably about 85 μm or less, and more preferably about 15 to 45 μm. For example, when the thickness of the below-described adhesive layer 5 is less than 10 μm, or when the adhesive layer 5 is not provided, the thickness of the heat-sealable resin layer 4 is preferably about 20 μm or more, and more preferably about 35 to 85 μm.

### [Adhesive Layer 5]

In the power storage device packaging material of the present disclosure, the adhesive layer 5 is a layer that is optionally provided between the heat-sealable resin layer 4 and the barrier layer 3 (or the corrosion-resistant film), in order to strongly bond these layers.

The adhesive layer 5 is formed of a resin capable of bonding the barrier layer 3 and the heat-sealable resin layer 4. Examples of the resin to be used for forming the adhesive layer 5 may include the same adhesives as those mentioned for the adhesive agent layer 2. In view of strongly bonding the adhesive layer 5 to the heat-sealable resin layer 4, the resin to be used for forming the adhesive layer 5 preferably contains a polyolefin backbone, and examples of the resin include the polyolefin and the acid-modified polyolefin as mentioned above for the heat-sealable resin layer 4. On the other hand, in view of strongly bonding the adhesive layer 5 to the barrier layer 3, the adhesive layer 5 preferably contains an acid-modified polyolefin. Examples of the acid-modification component include dicarboxylic acids, such as maleic acid, itaconic acid, succinic acid, and adipic acid, or anhydrides thereof, acrylic acid, and methacrylic acid, with maleic anhydride being most preferred in view of ease of modification and versatility. In view of the heat resistance of the power storage device packaging material, the olefin component is preferably a polypropylene resin, and the adhesive layer 5 most preferably contains a maleic anhydride-modified polypropylene.

When the resin to be used for forming the adhesive layer 5 contains a polyolefin backbone, the adhesive layer 5 preferably contains a resin containing a polyolefin backbone as a main component, more preferably contains an acid-modified polyolefin as a main component, and still more preferably contains an acid-modified polypropylene as a main component. As used herein, the term “main component” means a resin component whose content is, for example, 50% by mass or more, preferably 60% by mass or more, more preferably 70% by mass or more, still more preferably 80% by mass or more, even more preferably 90% by mass or more, still more preferably 95% by mass or more, even more preferably 98% by mass or more, and still more preferably 99% by mass or more, among the resin components contained in the adhesive layer 5. For example, the phrase “the adhesive layer 5 contains an acid-modified polypropylene as a main component” means that the acid-modified polypropylene content is, for example, 50% by mass or more, preferably 60% by mass or more, more preferably 70% by mass or more, still more preferably 80% by mass or more, even more preferably 90% by mass or more, still more preferably 95% by mass or more, even more preferably 98% by mass or more, and still more preferably 99% by mass or more, among the resin components contained in the adhesive layer 5.

The inclusion of the polyolefin backbone in the resin constituting the adhesive layer 5 can be analyzed by, for example, infrared spectroscopy or gas chromatography-mass spectrometry, although the analytical method is not limited thereto. The inclusion of an acid-modified polyolefin in the resin constituting the adhesive layer 5 can be analyzed as follows. When, for example, a maleic anhydride-modified polyolefin is measured by infrared spectroscopy, peaks derived from maleic anhydride are detected at a wavelength near 1760 cm⁻¹ and a wavelength near 1780 cm⁻¹. However, if the degree of acid modification is low, the peaks may be so small that they cannot be detected. In that case, the analysis can be performed by nuclear magnetic resonance spectroscopy.

Furthermore, in view of ensuring the durability such as heat resistance and contents resistance of the power storage device packaging material, and also ensuring the moldability while reducing the thickness of the power storage device packaging material, the adhesive layer 5 is more preferably a cured product of a resin composition containing an acid-modified polyolefin and a curing agent. Preferred examples of the acid-modified polyolefin include the same acid-modified polyolefins as those mentioned above.

Preferably, the adhesive layer 5 is a cured product of a resin composition containing an acid-modified polyolefin and at least one selected from the group consisting of a compound having an isocyanate group, a compound having an oxazoline group, and a compound having an epoxy group. Particularly preferably, the adhesive layer 5 is a cured product of a resin composition containing an acid-modified polyolefin and at least one selected from the group consisting of a compound having an isocyanate group and a compound having an epoxy group. The adhesive layer 5 preferably contains at least one selected from the group consisting of a polyurethane, a polyester, and an epoxy resin, and more preferably contains a polyurethane and an epoxy resin. Preferred examples of the polyester include an ester resin produced by reacting an epoxy group and a maleic anhydride group, and an amide ester resin produced by reacting an oxazoline group and a maleic anhydride group. When unreacted matter of the curing agent such as the compound having an isocyanate group, the compound having an oxazoline group, or the epoxy resin remains in the adhesive layer 5, the presence of the unreacted matter can be confirmed using a method selected from, for example, infrared spectroscopy, Raman spectroscopy, and time-of-flight secondary ion mass spectrometry (TOF-SIMS).

In view of further improving the adhesion between the barrier layer 3 and the adhesive layer 5, the adhesive layer 5 is preferably a cured product of a resin composition containing a curing agent having at least one selected from the group consisting of an oxygen atom, a heterocyclic ring, a C═N bond, and a C—O—C bond. Examples of the curing agent having a heterocyclic ring include a curing agent having an oxazoline group and a curing agent having an epoxy group. Examples of the curing agent having a C═N bond include a curing agent having an oxazoline group and a curing agent having an isocyanate group. Examples of the curing agent having a C—O—C bond include a curing agent having an oxazoline group and a curing agent having an epoxy group. Whether the adhesive layer 5 is a cured product of a resin composition containing these curing agents can be confirmed using a method such as gas chromatography-mass spectrometry (GCMS), infrared spectroscopy (IR), time-of-flight secondary ion mass spectrometry (TOF-SIMS), or X-ray photoelectron spectroscopy (XPS).

While the compound having an isocyanate group is not specifically limited, it is preferably a polyfunctional isocyanate compound, in view of effectively improving the adhesion between the barrier layer 3 and the adhesive layer 5. The polyfunctional isocyanate compound is not specifically limited as long as it is a compound having two or more isocyanate groups. Specific examples of polyfunctional isocyanate-based curing agents include pentane diisocyanate (PDI), isophorone diisocyanate (IPDI), hexamethylene diisocyanate (HDI), tolylene diisocyanate (TDI), and diphenylmethane diisocyanate (MDI), as well as polymer or isocyanurate forms thereof, mixtures thereof, or copolymers thereof with other polymers. Examples also include adducts, biurets, and isocyanurates.

The content of the compound having an isocyanate group in the adhesive layer 5 is preferably in the range of 0.1 to 50% by mass, and more preferably in the range of 0.5 to 40% by mass, in the resin composition constituting the adhesive layer 5. This can effectively improve the adhesion between the barrier layer 3 and the adhesive layer 5.

The compound having an oxazoline group is not specifically limited as long as it is a compound having an oxazoline backbone. Specific examples of the compound having an oxazoline group include those having a polystyrene main chain and those having an acrylic main chain. Examples of commercial products include the Epocros series from Nippon Shokubai Co., Ltd.

The content of the compound having an oxazoline group in the adhesive layer 5 is preferably in the range of 0.1 to 50% by mass, and more preferably in the range of 0.5 to 40% by mass, in the resin composition constituting the adhesive layer 5. This can effectively improve the adhesion between the barrier layer 3 and the adhesive layer 5.

Examples of the compound having an epoxy group include an epoxy resin. The epoxy resin is not specifically limited as long as it is a resin capable of forming a crosslinked structure with epoxy groups present in the molecule, and may be any of known epoxy resins. The weight average molecular weight of the epoxy resin is preferably about 50 to 2000, more preferably about 100 to 1000, and still more preferably about 200 to 800. As used herein, the weight average molecular weight of the epoxy resin is the value as measured by gel permeation chromatography (GPC), measured under conditions using polystyrene as standard samples.

Specific examples of the epoxy resin include glycidyl ether derivative of trimethylolpropane, bisphenol A diglycidyl ether, modified bisphenol A diglycidyl ether, bisphenol F-type glycidyl ether, novolac glycidyl ether, glycerol polyglycidyl ether, and polyglycerol polyglycidyl ether. These epoxy resins may be used alone or in combination.

The content of the epoxy resin in the adhesive layer 5 is preferably in the range of 0.1 to 50% by mass, and more preferably in the range of 0.5 to 40% by mass, in the resin composition constituting the adhesive layer 5. This can effectively improve the adhesion between the barrier layer 3 and the adhesive layer 5.

The polyurethane is not specifically limited and may be any of known polyurethanes. The adhesive layer 5 may be, for example, a cured product of a two-component curable polyurethane.

The content of the polyurethane in the adhesive layer 5 is preferably in the range of 0.1 to 50% by mass, and more preferably in the range of 0.5 to 40% by mass, in the resin composition constituting the adhesive layer 5. This can effectively improve the adhesion between the barrier layer 3 and the adhesive layer 5, in an atmosphere containing a component that induces corrosion of the barrier layer, such as an electrolytic solution.

When the adhesive layer 5 is a cured product of a resin composition containing the above-mentioned acid-modified polyolefin and at least one selected from the group consisting of a compound having an isocyanate group, a compound having an oxazoline group, and an epoxy resin, the acid-modified polyolefin functions as a base resin, and each of the compound having an isocyanate group, the compound having an oxazoline group, and the compound having an epoxy group functions as a curing agent.

The adhesive layer 5 may contain a modifier having a carbodiimide group.

A pre-formed resin film may be used as the adhesive layer 5 when laminating the adhesive layer 5 with the barrier layer 3, the heat-sealable resin layer 4, or the like to produce the power storage device packaging material 10 of the present disclosure. Alternatively, the heat-sealable resin forming the adhesive layer 5 may be formed into a film on a surface of the barrier layer 3, the heat-sealable resin layer 4, or the like by extrusion, coating, or the like, and used as the adhesive layer 5 formed of a resin film.

The thickness of the adhesive layer 5 is preferably about 50 μm or less, about 40 μm or less, about 30 μm or less, about 20 μm or less, or about 5 μm or less. On the other hand, the thickness of the adhesive layer 5 is preferably about 0.1 μm or more or about 0.5 μm or more. Preferred ranges of the thickness of the adhesive layer 5 include from about 0.1 to 50 μm, from about 0.1 to 40 μm, from about 0.1 to 30 μm, from about 0.1 to 20 μm, from about 0.1 to 5 μm, from about 0.5 to 50 μm, from about 0.5 to 40 μm, from about 0.5 to 30 μm, from about 0.5 to 20 μm, and from about 0.5 to 5 μm. More specifically, when the adhesive layer 5 is an adhesive as mentioned for the adhesive agent layer 2 or a cured product of an acid-modified polyolefin and a curing agent, the thickness of the adhesive layer 5 is preferably about 1 to 10 μm, and more preferably about 1 to 5 μm. When the adhesive layer 5 is formed of a resin as mentioned for the heat-sealable resin layer 4, the thickness of the adhesive layer 5 is preferably about 2 to 50 μm, and more preferably about 10 to 40 μm. When the adhesive layer 5 is an adhesive as mentioned for the adhesive agent layer 2 or a cured product of a resin composition containing an acid-modified polyolefin and a curing agent, the adhesive layer 5 can be formed by, for example, applying the resin composition, and curing by heating or the like. When the adhesive layer 5 is formed of a resin as mentioned for the heat-sealable resin layer 4, the adhesive layer 5 can be formed by, for example, extrusion of the heat-sealable resin layer 4 and the adhesive layer 5. When the heat-sealable resin layer 4 and the adhesive layer 5 are formed by co-extrusion, the total thickness of the heat-sealable resin layer 4 and the adhesive layer 5 has a lower limit of, for example, 35 μm, 55 μm, or 75 μm, and an upper limit of, for example, 45 μm, 65 μm, or 85 μm. Preferred ranges include from 35 to 45 μm, from 35 to 65 μm, from 35 to 85 μm, from 55 to 65 μm, from 55 to 85 μm, and from 75 to 85 μm.

### [Surface Coating Layer 6]

The power storage device packaging material of the present disclosure may optionally include a surface coating layer 6 on the base material layer 1 (opposite to the barrier layer 3 on the base material layer 1) for at least one of the purposes of improving the designability, electrolytic solution resistance, scratch resistance, and moldability, for example. The surface coating layer 6 is a layer positioned as the outermost layer of the power storage device packaging material when a power storage device is assembled using the power storage device packaging material.

Examples of the resin forming the surface coating layer 6 include resins such as polyvinylidene chloride, polyesters, polyamides, epoxy resins, acrylic resins, fluororesins, polyurethanes, silicone resins, and phenol resins, and modified resins thereof. The resin forming the surface coating layer 6 may also be a copolymer of these resins or a modified copolymer thereof. The resin forming the surface coating layer 6 may also be a mixture of these resins. The resin is preferably a curable resin. That is, the surface coating layer 6 is preferably formed of a cured product of a resin composition containing a curable resin.

When the resin forming the surface coating layer 6 is a curable resin, the resin may be either a one-component curable resin or a two-component curable resin, preferably a two-component curable resin. The two-component curable resin may be, for example, a two-component curable polyurethane, a two-component curable polyester, or a two-component curable epoxy resin. Among the above, a two-component curable polyurethane is preferred.

The two-component curable polyurethane may be, for example, a polyurethane that contains a first agent containing a polyol compound and a second agent containing an isocyanate compound. The two-component curable polyurethane is preferably a two-component curable polyurethane that contains a polyol such as a polyester polyol, a polyether polyol, or an acrylic polyol as the first agent, and an aromatic or aliphatic polyisocyanate as the second agent. The polyurethane may be, for example, a polyurethane that contains a polyurethane compound obtained beforehand by reacting a polyol compound and an isocyanate compound, and an isocyanate compound. The polyurethane may be, for example, a polyurethane that contains a polyurethane compound obtained beforehand by reacting a polyol compound and an isocyanate compound, and a polyol compound. The polyurethane may be, for example, a polyurethane produced by curing a polyurethane compound obtained beforehand by reacting a polyol compound and an isocyanate compound, by reacting with moisture such as moisture in the air. The polyol compound is preferably a polyester polyol having a hydroxy group at a side chain, in addition to the hydroxy groups at the ends of the repeating unit. Examples of the second agent include aliphatic, alicyclic, aromatic, and aromatic and aliphatic isocyanate compounds. Examples of isocyanate compounds include hexamethylene diisocyanate (HDI), xylylene diisocyanate (XDI), isophorone diisocyanate (IPDI), hydrogenated XDI (H6XDI), hydrogenated MDI (H12MDI), tolylene diisocyanate (TDI), diphenylmethane diisocyanate (MDI), and naphthalene diisocyanate (NDI). Examples also include modified polyfunctional isocyanates obtained from one, or two or more of these diisocyanates. A multimer (for example, a trimer) may also be used as a polyisocyanate compound. Examples of such multimers include adducts, biurets, and isocyanurates. An aliphatic isocyanate compound refers to an isocyanate having an aliphatic group and no aromatic ring, an alicyclic isocyanate compound refers to an isocyanate having an alicyclic hydrocarbon group, and an aromatic isocyanate compound refers to an isocyanate having an aromatic ring. When the surface coating layer 6 is formed of a polyurethane, the power storage device packaging material is provided with excellent electrolytic solution resistance.

At least one of the surface and the inside of the surface coating layer 6 may optionally contain additives, such as the above-mentioned lubricants, anti-blocking agents, matting agents, flame retardants, antioxidants, tackifiers, and anti-static agents, according to the functionality and the like to be imparted to the surface coating layer 6 and the surface thereof. Examples of the additives include fine particles having an average particle diameter of about 0.5 nm to 5 μm. The average particle diameter of the additives is the median diameter as measured using a laser diffraction/scattering particle size distribution analyzer.

The additives may be either inorganic or organic. The additives are also not specifically limited in shape and may be spherical, fibrous, plate-like, amorphous, or flake-like, for example.

Specific examples of the additives include talc, silica, graphite, kaolin, montmorillonite, mica, hydrotalcite, silica gel, zeolite, aluminum hydroxide, magnesium hydroxide, zinc oxide, magnesium oxide, aluminum oxide, neodymium oxide, antimony oxide, titanium oxide, cerium oxide, calcium sulfate, barium sulfate, calcium carbonate, calcium silicate, lithium carbonate, calcium benzoate, calcium oxalate, magnesium stearate, alumina, carbon black, carbon nanotubes, high-melting-point nylons, acrylate resins, crosslinked acrylic, crosslinked styrene, crosslinked polyethylene, benzoguanamine, gold, aluminum, copper, and nickel. These additives may be used alone or in combination. Among these additives, silica, barium sulfate, and titanium oxide are preferred in view of dispersion stability, costs, and the like. Surfaces of the additives may be subjected to various types of surface treatment, such as insulation treatment and dispersibility enhancing treatment.

Examples of methods of forming the surface coating layer 6 include, but are not limited to, applying the resin for forming the surface coating layer 6. When an additive is to be used in the surface coating layer 6, the resin blended with the additive may be applied.

The thickness of the surface coating layer 6 is not specifically limited as long as the above-described function as the surface coating layer 6 is exhibited; for example, it is about 0.5 to 10 μm, and preferably about 1 to 5 μm.

### 3. Method for Producing the Power Storage Device Packaging Material

The method for producing the power storage device packaging material is not specifically limited as long as it produces a laminate in which the layers of the power storage device packaging material of the present invention are laminated. The method may, for example, comprise the step of providing a laminate in which at least a base material layer, a barrier layer, and a heat-sealable resin layer are laminated in this order from an outer side, wherein the barrier layer has a thickness of 38 μm or more, the laminate has a bending resistance of 1.1 mN or more, as measured under the above-described conditions in accordance with the provisions of JIS L1085: 1998, and the number of double folds until a pinhole is formed in the laminate is 600 or more, as measured under the above-described conditions in accordance with the provisions of JIS P8115: 2001.

One example of the method for producing the power storage device packaging material of the present invention is as follows: First, a laminate including the base material layer 1, the adhesive agent layer 2, and the barrier layer 3 in this order (the laminate may be hereinafter denoted as the “laminate A”) is formed. Specifically, the laminate A can be formed by dry lamination as follows: The adhesive to be used for forming the adhesive agent layer 2 is applied to the base material layer 1 or to the barrier layer 3 whose surface(s) have been optionally subjected to a chemical conversion treatment, using a coating method such as gravure coating or roll coating, and dried. Then, the barrier layer 3 or the base material layer 1 is laminated thereon, and the adhesive agent layer 2 is cured.

Subsequently, the heat-sealable resin layer 4 is laminated on the barrier layer 3 of the laminate A. When the heat-sealable resin layer 4 is to be laminated directly on the barrier layer 3, the heat-sealable resin layer 4 may be laminated onto the barrier layer 3 of the laminate A, using a method such as thermal lamination or extrusion lamination. When the adhesive layer 5 is to be provided between the barrier layer 3 and the heat-sealable resin layer 4, the adhesive layer 5 and the heat-sealable resin layer 4 can be laminated using, for example, (1) extrusion lamination, (2) thermal lamination, (3) sandwich lamination, or (4) dry lamination. Examples of extrusion lamination (1) include a method in which the adhesive layer 5 and the heat-sealable resin layer 4 are extruded to be laminated on the barrier layer 3 of the laminate A (co-extrusion lamination or tandem lamination). Examples of thermal lamination (2) include a method in which a laminate in which the adhesive layer 5 and the heat-sealable resin layer 4 are laminated is separately formed, and this laminate is laminated on the barrier layer 3 of the laminate A; and a method in which a laminate in which the adhesive layer 5 is laminated on the barrier layer 3 of the laminate A is formed, and this laminate is laminated to the heat-sealable resin layer 4. Examples of sandwich lamination (3) include a method in which the adhesive layer 5 that has been melted is poured between the barrier layer 3 of the laminate A and the heat-sealable resin layer 4 pre-formed into a sheet, and simultaneously the laminate A and the heat-sealable resin layer 4 are bonded via the adhesive layer 5. Examples of dry lamination (4) include a method in which the adhesive for forming the adhesive layer 5 is laminated on the barrier layer 3 of the laminate A by, for example, applying the adhesive onto the barrier layer 3 using solution coating and drying, or further baking, and then the heat-sealable resin layer 4 pre-formed into a sheet is laminated on the adhesive layer 5.

Next, the surface coating layer 6 is optionally laminated on the surface of the base material layer 1 opposite to the barrier layer 3. The surface coating layer 6 can be formed by, for example, applying the above-mentioned resin composition forming the surface coating layer 6 onto the surface of the base material layer 1, and curing. The order of the step of laminating the barrier layer 3 on the surface of the base material layer 1 and the step of laminating the surface coating layer 6 on the surface of the base material layer 1 is not specifically limited. For example, the surface coating layer 6 may be formed on the surface of the base material layer 1, and then the barrier layer 3 may be formed on the surface of the base material layer 1 opposite to the surface coating layer 6.

In the manner as described above, a laminate is formed including the optional surface coating layer 6/the base material layer 1/the optional adhesive agent layer 2/the barrier layer 3/the optional adhesive layer 5/the heat-sealable resin layer 4 in this order from the outer side. The laminate may optionally be further subjected to heat treatment, in order to strengthen the adhesiveness of the optional adhesive agent layer 2 and the optional adhesive layer 5. The laminate may also include a coloring layer between the base material layer 1 and the barrier layer 3, as described above.

### 4. Uses of the Power Storage Device Packaging Material

The power storage device packaging material of the present disclosure is used as a package for hermetically sealing and housing a power storage device element comprising a positive electrode, a negative electrode, and an electrolyte. That is, a power storage device can be obtained by housing the power storage device element comprising at least a positive electrode, a negative electrode, and an electrolyte in a package formed of the power storage device packaging material of the present disclosure.

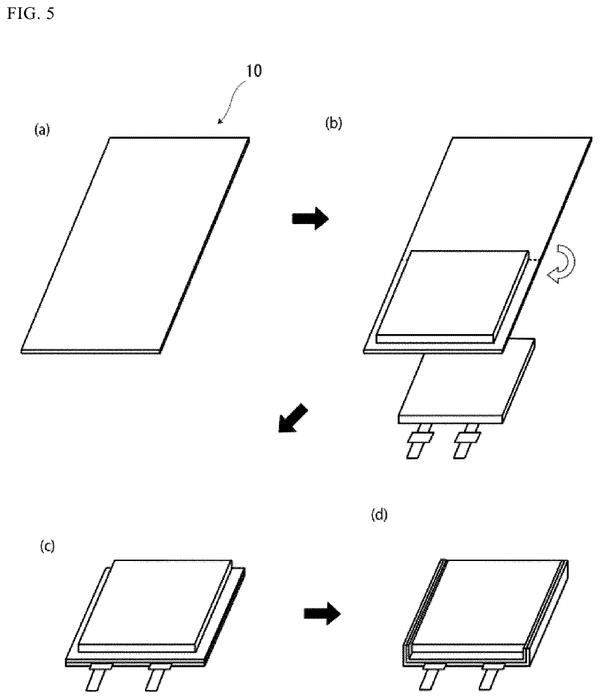

Specifically, the power storage device element comprising at least a positive electrode, a negative electrode, and an electrolyte is covered with the power storage device packaging material of the present disclosure such that a flange (region where the heat-sealable resin layer is brought into contact with another heat-sealable resin layer) can be formed on the periphery of the power storage device element, with a metal terminal connected to each of the positive electrode and the negative electrode protruding outside, and then the heat-sealable resin layers in the flange are heat-sealed to hermetically seal the power storage device element. This provides a power storage device using the power storage device packaging material. When the power storage device element is housed in the package formed of the power storage device packaging material of the present disclosure, the package is formed such that the heat-sealable resin layer region of the power storage device packaging material of the present disclosure is positioned on the inner side (surface in contact with the power storage device element). Two sheets of the power storage device packaging material may be superposed with their heat-sealable resin layers opposing each other, and peripheral regions of the superposed power storage device packaging materials may be heat-sealed to form a package. Alternatively, as in the example shown in FIG. 5, one sheet of the power storage device packaging material may be folded over, and peripheral regions thereof may be heat-sealed to form a package. When the power storage device packaging material is folded over, the sides other than the folded sides may be heat-sealed to form a package by three-side sealing, as in the example shown in FIG. 5. Alternatively, the power storage device packaging material may be folded over and four-side sealed such that a flange is formed. Alternatively, the power storage device packaging material may be wrapped around the power storage device element, the heat-sealable resin layers may be sealed to each other to form a heat-sealed region, and a lid or the like may be disposed to close the opening at each of the ends. Moreover, in the power storage device packaging material, a concave portion for housing the power storage device element may be formed by deep drawing or bulging. As in the example shown in FIG. 5, a concave portion may be provided in one sheet of the power storage device packaging material, but not in the other sheet. Alternatively, a concave portion may also be provided in the other sheet of the power storage device packaging material.

The power storage device packaging material of the present disclosure is suitable for use in power storage devices, such as batteries (including condensers and capacitors). The power storage device packaging material of the present disclosure may be used for either primary batteries or secondary batteries, but are preferably used for secondary batteries. While the type of secondary batteries to which the power storage device packaging material of the present disclosure is applied is not limited, examples include lithium ion batteries, lithium ion polymer batteries, all-solid-state batteries, semi-solid-state batteries, quasi-solid-state batteries, polymer batteries, all-polymer batteries, lead storage batteries, nickel-hydrogen storage batteries, nickel-cadmium storage batteries, nickel-iron storage batteries, nickel-zinc storage batteries, silver oxide-zinc storage batteries, metal-air batteries, polyvalent cation batteries, condensers, and capacitors. Among these secondary batteries, preferred secondary batteries to which the power storage device packaging material of the present disclosure is applied include lithium ion batteries and lithium ion polymer batteries.

### EXAMPLES

The present disclosure will be hereinafter described in detail with reference to examples and comparative examples, although the present disclosure is not limited to the examples.

### <Production of Power Storage Device Packaging Materials>

### Examples 1-10 and Comparative Examples 1-7 and 10

As a base material layer, a stretched nylon (ONy) film (each having a thickness as shown in Table 1) was prepared. As a barrier layer, an aluminum foil (JIS H4160: 1994 A8021H-O (each having a thickness as shown in Table 1)) was prepared. A two-component urethane adhesive A (a polyol compound and an aromatic isocyanate compound) was used to laminate the aluminum foil and the base material layer by dry lamination such that the thickness of the adhesive agent layer after curing was 3 μm, and then the resulting laminate was subjected to aging treatment to prepare a laminate of the base material layer/the adhesive agent layer/the barrier layer. Both surfaces of the aluminum foil had been subjected to chemical conversion treatment. The chemical conversion treatment of the aluminum foil was performed by applying a treatment solution containing a phenol resin, a chromium fluoride compound, and phosphoric acid to both surfaces of the aluminum foil by roll coating such that the amount of chromium applied was 10 mg/m² (dry mass), and baking.

Next, an adhesive layer and a heat-sealable resin layer were laminated on the barrier layer of each laminate obtained above. Specifically, a maleic anhydride-modified polypropylene as the adhesive layer and a random polypropylene as the heat-sealable resin layer were melt co-extruded such that each layer had a thickness as shown in Table 1, to laminate the adhesive layer/the heat-sealable resin layer on the barrier layer. This resulted in a power storage device packaging material sequentially having the base material layer/the adhesive agent layer/the barrier layer/the adhesive layer/the heat-sealable resin layer.

### Examples 11-13 and Comparative Example 8

As a base material layer, a polyethylene terephthalate (PET) film (thickness: 12 μm) and a stretched nylon (ONy) film (each having a thickness as shown in Table 1) were prepared. A two-component urethane adhesive (a polyol compound and an aromatic isocyanate compound) was used to bond the PET film and the ONy film via the adhesive agent layer such that the thickness of the adhesive agent layer after curing was 3 μm. As a barrier layer, an aluminum foil (JIS H4160: 1994 A8021H-O (each having a thickness as shown in Table 1)) was prepared. Next, the two-component urethane adhesive A (a polyol compound and an aromatic isocyanate compound) was used in Examples 11 and 13, and Comparative Example 8, and the two-component urethane adhesive B (a polyol compound and an aromatic isocyanate compound) was used in Example 12, to laminate the aluminum foil and the base material layer (ONy side) by dry lamination such that the thickness of the adhesive agent layer after curing was 3 μm, and then the resulting laminate was subjected to aging treatment to prepare a laminate of the base material layer/the adhesive agent layer/the barrier layer. As the two-component adhesive (a polyol compound and an aromatic isocyanate compound) to be used between the polyethylene terephthalate (PET) film and the stretched nylon (ONy) film, the two-component urethane adhesive A (a polyol compound and an aromatic isocyanate compound) was used in Examples 11 and 13, and Comparative Example 8, and the two-component urethane adhesive B (a polyol compound and an aromatic isocyanate compound) was used in Example 12. Both surfaces of the aluminum foil had been subjected to chemical conversion treatment. The chemical conversion treatment of the aluminum foil was performed by applying a treatment solution containing a phenol resin, a chromium fluoride compound, and phosphoric acid to both surfaces of the aluminum foil by roll coating such that the amount of chromium applied was 10 mg/m² (dry mass), and baking.

Next, an adhesive layer and a heat-sealable resin layer were laminated on the barrier layer of each laminate obtained above. Specifically, a maleic anhydride-modified polypropylene (PPa) as the adhesive layer and a random polypropylene (PP) as the heat-sealable resin layer were melt co-extruded such that each layer had a thickness as shown in Table 1, to laminate the adhesive layer/the heat-sealable resin layer on the barrier layer. This resulted in a power storage device packaging material sequentially having the base material layer/the adhesive agent layer/the barrier layer/the Example 14

A laminate of the base material layer/the adhesive agent layer/the barrier layer was prepared as in Examples 1-10 and Comparative Examples 1-7 and 10. Next, an adhesive layer and a heat-sealable resin layer were laminated on the barrier layer of the laminate obtained above. Specifically, a two-component curable adhesive (an acid-modified polypropylene and an epoxy compound) was applied to the surface of the barrier layer to form an adhesive layer (thickness after curing: 3 μm) on the barrier layer. Then, an unstretched polypropylene film (CPP, with a thickness of 40 μm as shown in Table 1) as the heat-sealable resin layer was laminated onto the adhesive layer by dry lamination. Next, the resulting laminate was aged and heated. This resulted in a power storage device packaging material sequentially having the base material layer/the adhesive agent layer/the barrier layer/the adhesive layer/the heat-sealable resin layer.

### Comparative Example 9

A laminate of the base material layer/the adhesive agent layer/the barrier layer was prepared as in Examples 1-10 and Comparative Examples 1-7 and 10, except that a stainless steel foil (SUS304; thickness: 20 μm) was used as the barrier layer, instead of the aluminum alloy foil. Next, an adhesive layer and a heat-sealable resin layer were laminated on the barrier layer of the laminate obtained above. Specifically, a two-component curable adhesive (an acid-modified polypropylene and an epoxy compound) was applied to the surface of the barrier layer to form an adhesive layer (thickness after curing: 3 μm) on the barrier layer. Then, an unstretched polypropylene film (CPP, with a thickness of 23 μm as shown in Table 1) as the heat-sealable resin layer was laminated onto the adhesive layer by dry lamination. Next, the resulting laminate was aged and heated. This resulted in a power storage device packaging material sequentially having the base material layer/the adhesive agent layer/the barrier layer/the

### <Measurement of the Bending Resistance>

The bending resistance of each power storage device packaging material was measured in accordance with the provisions of JIS L1085: 1998, using a Gurley stiffness tester (Digital Gurley Stiffness Tester (the model GS-3) from Toyo Seiki Seisaku-sho, Ltd.). A sample size was 25 mm (MD)×51 mm (TD); the width of 51 mm was chucked; a weight of 25 g was used for measurement of a bending resistance of less than 2.0 mN, and a weight of 200 g was used for measurement of a bending resistance of 2.0 mN or more; five measurements were performed for each of left and right directions, at a rotation speed of 2.0 rpm; and an average of a total of 10 measured values was determined as the bending resistance. The sample length adjustment position and the weight position were each set to the adjustment positions specific to the testing machine. Specifically, the weight was placed in the position “c” shown in FIG. 8 in 6.10.3 of JIS L1085: 1998. The results are shown in Table 1.

### <Measurement of the Number of Double Folds Until a Pinhole is Formed>

The number of double folds until a pinhole is formed in the barrier layer of the power storage device packaging material was measured in accordance with the provisions of JIS P8115: 2001, using an MIT folding endurance tester (MIT type Folding Endurance Tester (the model D-2) from Toyo Seiki Seisaku-sho, Ltd.). The number of double folds until a pinhole is formed was measured under the following conditions: a sample size of 150 mm (MD)×15 mm (TD); a load of 1000 g; a folding angle of 45°; a folding speed of 175 times/min; and a chuck shape with an edge radius R of 0.38 mm. The results are shown in Table 1.

### <Measurement of the Tensile Elastic Moduli of the Base Material Layer and the Heat-Sealable Resin Layer>

The tensile elastic modulus of the base material layer was measured in accordance with the provisions of JIS K7127: 1999, using a rectangular specimen with a width of 15 mm, by pulling the specimen in the MD direction at a speed of 200 mm/min, in a measurement environment at 23° C. and 50% RH. The tensile elastic modulus of the heat-sealable resin layer was measured in accordance with the provisions of JIS K7161-2:2014, by preparing a 5A dumbbell-shaped specimen and subjecting the specimen to measurement at a speed of 500 mm/min, in a measurement environment at 23° C. and 50% RH. When the base material layer or the heat-sealable resin layer was composed of a plurality of layers, the tensile elastic modulus was measured for each layer, and the value of tensile elastic modulus was calculated in terms of the thickness ratio. The results are shown in Table 1. For example, when the base material layer is composed of two layers, with a base material A and a base material B being laminated with an adhesive, the elastic modulus of each of the base materials A and B is measured without considering the elastic modulus of the adhesive agent layer, and the elastic modulus is calculated in terms of the thickness ratio between the base materials A and B.

### <Evaluation of Moldability>

Each power storage device packaging material was cut into a rectangle with a length (machine direction (MD)) of 200 mm and a width (transverse direction (TD)) of 360 mm for use as a test sample. Using a rectangular molding die with an opening size of 90 mm (MD direction)×250 mm (TD direction) (female die; with a surface having a maximum height of roughness profile (nominal value of Rz) of 3.2 μm, as specified in Table 2 of JIS B 0659-1:2002 Appendix 1 (Referential) Surface Roughness Standard Specimens for Comparison; corner R: 2.0 mm; ridge R: 1.0 mm) and a corresponding molding die (male die; with a surface having a maximum height of roughness profile (nominal value of Rz) of 1.6 μm, as specified in Table 2 of JIS B 0659-1:2002 Appendix 1 (Referential) Surface Roughness Standard Specimens for Comparison; corner R: 2.0 mm; ridge R: 1.0 mm), ten samples for each power storage device packaging material were cold-molded (draw-in one-step molding) at a pressing pressure (surface pressure) of 0.5 MPa while varying the molding depth from a molding depth of 0.5 mm in 0.5 mm increments. Here, molding was performed with the test sample being placed on the female die such that the heat-sealable resin layer side was positioned on the male die side. The clearance between the male die and the female die was 0.3 mm. The cold-molded samples were inspected for pinholes or cracks in the aluminum alloy foil, by directing light to the samples with a penlight in a dark room and allowing the light to pass therethrough. The deepest molding depth at which no pinholes or cracks occurred in the aluminum alloy foil for all the ten samples was defined as the limit molding depth. For each power storage device packaging material, moldability was evaluated based on the four levels of criteria as shown below. The results are shown in Table 1.
A+: a limit molding depth of 9.0 mm or more
A: a limit molding depth of 7.0 mm or more and 8.5 mm or less
B: a limit molding depth of 5.0 mm or more and 6.5 mm or less
C: a limit molding depth of 4.5 mm or less

TABLE 1

| | Lamineted structure of power storage device packaging material | | | | | | | Adhesive | Elastic moduli |
|---|---|---|---|---|---|---|---|---|---|
| | | Adhesive | | Adhesive | | | | between base | Base |
| | | agent | | agent | Barrier | | | material | material |
| | PET | layer | Ony | layer | layer | PPa | PP | layer | layer |
| | μm | μm | μm | μm | μm | μm | μm | and barrier | MPa |
| Ex. 1 | — | — | 25 | 3 | 40 | 20 | 15 | A | 2700 |
| Ex. 2 | — | — | 25 | 3 | 40 | 22.5 | 22.5 | A | 2700 |
| Ex. 3 | — | — | 25 | 3 | 40 | 40 | 40 | A | 2700 |
| Ex. 4 | — | — | 20 | 3 | 40 | 20 | 15 | A | 2700 |
| Ex. 5 | — | — | 20 | 3 | 40 | 22.5 | 22.5 | A | 2700 |
| Ex. 6 | — | — | 20 | 3 | 40 | 40 | 40 | A | 2700 |
| Ex. 7 | — | — | 15 | 3 | 40 | 14 | 10 | A | 2700 |
| Ex. 8 | — | — | 15 | 3 | 40 | 20 | 15 | A | 2700 |
| Ex. 9 | — | — | 15 | 3 | 40 | 22.5 | 22.5 | A | 2700 |
| Ex. 10 | — | — | 15 | 3 | 40 | 40 | 40 | A | 2700 |
| Ex. 11 | 12 | 3 | 15 | 3 | 40 | 40 | 40 | A | 3233 |
| Ex. 12 | 12 | 3 | 15 | 3 | 40 | 40 | 40 | B | 3233 |
| Ex. 13 | 12 | 3 | 25 | 3 | 60 | 40 | 40 | A | 3089 |
| Ex. 14 | — | — | 25 | 3 | 40 | CPP40 | | A | 2700 |
| Comp. Ex. 1 | — | — | 12 | 3 | 15 | 14 | 10 | A | 2700 |
| Comp. Ex. 2 | — | — | 12 | 3 | 20 | 14 | 10 | A | 2700 |
| Comp. Ex. 3 | — | — | 12 | 3 | 25 | 14 | 10 | A | 2700 |
| Comp. Ex. 4 | — | — | 20 | 3 | 30 | 14 | 10 | A | 2700 |
| Comp. Ex. 5 | — | — | 15 | 3 | 35 | 20 | 15 | A | 2700 |
| Comp. Ex. 6 | — | — | 25 | 3 | 40 | 14 | 10 | A | 2700 |
| Comp. Ex. 7 | — | — | 20 | 3 | 40 | 14 | 10 | A | 2700 |
| Comp. Ex. 8 | 12 | 3 | 25 | 3 | 30 | 30 | 30 | A | 3089 |
| Comp. Ex. 9 | — | — | 12 | 3 | SUS20 | CPP23 | | A | 2700 |
| Comp. Ex. 10 | — | — | 15 | 3 | 35 | 20 | 15 | A | 2700 |

| | | Ratio of elastic moguli | | Number of | |
|---|---|---|---|---|---|
| | Elastic moduli | (base material | | folds until | |
| | Heat-sealable | layer/heat | Bending | a pinhole is | Evaluation |
| | resin layer | sealable resin layer) | resistance | formed | of |
| | MPa | — | mN | times | moldability |
| Ex. 1 | 421 | 4.6 | 1.4 | 600 | A |
| Ex. 2 | 425 | 3.5 | 1.5 | 800 | A |
| Ex. 3 | 421 | 2.0 | 2.0 | 1400 | A |
| Ex. 4 | 421 | 3.7 | 1.5 | 700 | A |
| Ex. 5 | 425 | 2.8 | 1.7 | 1300 | A |
| Ex. 6 | 421 | 1.6 | 2.4 | 2400 | A |
| Ex. 7 | 421 | 4.0 | 1.1 | 800 | A |
| Ex. 8 | 421 | 2.7 | 1.3 | 1000 | A |
| Ex. 9 | 425 | 2.1 | 1.5 | 1600 | A |
| Ex. 10 | 421 | 1.2 | 2.4 | 3100 | A |
| Ex. 11 | 421 | 2.6 | 2.3 | 1000 | A |
| Ex. 12 | 421 | 2.6 | 2.2 | 1600 | A |
| Ex. 13 | 421 | 3.4 | 4.2 | 700 | A+ |
| Ex. 14 | 600 | 2.8 | 1.1 | 800 | A |
| Comp. Ex. 1 | 421 | 3.2 | 0.2 | 1400 | C |
| Comp. Ex. 2 | 421 | 3.2 | 0.3 | 800 | C |
| Comp. Ex. 3 | 421 | 3.2 | 0.4 | 800 | B |
| Comp. Ex. 4 | 421 | 5.3 | 0.8 | 500 | A |
| Comp. Ex. 5 | 431 | 2.7 | 1.0 | 500 | A |
| Comp. Ex. 6 | 421 | 6.7 | 1.3 | 400 | A |
| Comp. Ex. 7 | 421 | 5.3 | 1.1 | 500 | A |
| Comp. Ex. 8 | 421 | 4.5 | 6.4 | 400 | A+ |
| Comp. Ex. 9 | 600 | 2.1 | 0.7 | 400 | C |
| Comp. Ex. 10 | 300 | 3.9 | 1.0 | 300 | A |

In Table 1, PET denotes polyethylene terephthalate, ONy denotes a stretched nylon film, PPa denotes a maleic anhydride-modified polypropylene, and PP denotes a random polypropylene.

As described above, the present disclosure provides aspects of the invention as set forth below:

Item 1. A power storage device packaging material, comprising a laminate comprising at least a base material layer, a barrier layer, and a heat-sealable resin layer in this order from an outer side,
wherein the barrier layer has a thickness of 38 μm or more;
the laminate has a bending resistance of 1.1 mN or more, as measured under the following conditions in accordance with the provisions of JIS L1085: 1998:

### <Conditions for Measuring the Bending Resistance>

a Gurley stiffness tester is used; a sample size is 25 mm (MD)×51 mm (TD); the width of 51 mm is chucked; a weight of 25 g is used for measurement of a bending resistance of less than 2.0 mN, and a weight of 200 g is used for measurement of a bending resistance of 2.0 mN or more; five measurements are performed for each of left and right directions, at a rotation speed of 2.0 rpm; and an average of a total of 10 measured values is determined as the bending resistance; and
the number of double folds until a pinhole is formed in the laminate is 600 or more, as measured under the following conditions in accordance with the provisions of JIS P8115: 2001:

### <Conditions for Measuring the Number of Double Folds Until a Pinhole is Formed>

an MIT folding endurance tester is used, and the number of double folds until a pinhole is formed is measured under the following conditions: a sample size of 150 mm (MD)×15 mm (TD); a load of 1000 g; a folding angle of 45°; a folding speed of 175 times/min; and a chuck shape with an edge radius R of 0.38 mm.

Item 2. The power storage device packaging material according to item 1, wherein a ratio of tensile elastic modulus of the base material layer to tensile elastic modulus of the heat-sealable resin layer is 5.0 times or less.

Item 3. The power storage device packaging material according to item 1 or 2, wherein the barrier layer is formed of an aluminum alloy foil.

Item 4. The power storage device packaging material according to item 3, wherein the aluminum alloy foil has a thickness of 60 μm or more.

Item 5. The power storage device packaging material according to any one of items 1 to 4, further comprising an adhesive layer between the barrier layer and the heat-sealable resin layer.

Item 6. The power storage device packaging material according to any one of items 1 to 5, wherein the laminate has a thickness of 70 μm or more.

Item 7. A method for producing a power storage device packaging material, comprising the step of:
providing a laminate in which at least a base material layer, a barrier layer, and a heat-sealable resin layer are laminated in this order from an outer side,
wherein the barrier layer has a thickness of 38 μm or more;
the laminate has a bending resistance of 1.1 mN or more, as measured under the following conditions in accordance with the provisions of JIS L1085: 1998:

### <Conditions for Measuring the Bending Resistance>

a Gurley stiffness tester is used; a sample size is 25 mm (MD)×51 mm (TD); the width of 51 mm is chucked; a weight of 25 g is used for measurement of a bending resistance of less than 2.0 mN, and a weight of 200 g is used for measurement of a bending resistance of 2.0 mN or more; five measurements are performed for each of left and right directions, at a rotation speed of 2.0 rpm; and an average of a total of 10 measured values is determined as the bending resistance; and
the number of double folds until a pinhole is formed in the laminate is 600 or more, as measured under the following conditions in accordance with the provisions of JIS P8115: 2001:

### <Conditions for Measuring the Number of Double Folds Until a Pinhole is Formed>

an MIT folding endurance tester is used, and the number of double folds until a pinhole is formed is measured under the following conditions: a sample size of 150 mm (MD)×15 mm (TD); a load of 1000 g; a folding angle of 45°; a folding speed of 175 times/min; and a chuck shape with an edge radius R of 0.38 mm.

Item 8. A power storage device comprising a power storage device element comprising at least a positive electrode, a negative electrode, and an electrolyte,
wherein the power storage device element is housed in a package formed of the power storage device packaging material according to any one of items 1 to 6.

### REFERENCE SIGNS LIST

1: base material layer
2: adhesive agent layer
3: barrier layer
4: heat-sealable resin layer
5: adhesive layer
6: surface coating layer
10: power storage device packaging material

1. A power storage device packaging material, comprising a laminate comprising at least a base material layer, a barrier layer, and a heat-sealable resin layer in this order from an outer side,
wherein the barrier layer has a thickness of 38 μm or more;
the laminate has a bending resistance of 1.1 mN or more, as measured under the following conditions in accordance with the provisions of JIS L1085: 1998:
<Conditions for measuring the bending resistance>
a Gurley stiffness tester is used; a sample size is 25 mm (MD) in length×51 mm (TD) in width; the width of 51 mm is chucked; a weight of 25 g is used for measurement of a bending resistance of less than 2.0 mN, and a weight of 200 g is used for measurement of a bending resistance of 2.0 mN or more; five measurements are performed for each of left and right directions, at a rotation speed of 2.0 rpm; and an average of a total of 10 measured values is determined as the bending resistance; and
the number of double folds until a pinhole is formed in the laminate is 600 or more, as measured under the following conditions in accordance with the provisions of JIS P8115: 2001:
<Conditions for measuring the number of double folds until a pinhole is formed>
an MIT folding endurance tester is used, and the number of double folds until a pinhole is formed is measured under the following conditions: a sample size of 150 mm (MD)×15 mm (TD); a load of 1000 g; a folding angle of 45°; a folding speed of 175 times/min; and a chuck shape with an edge radius R of 0.38 mm.

2. The power storage device packaging material according to claim 1, wherein a ratio of tensile elastic modulus of the base material layer to tensile elastic modulus of the heat-sealable resin layer is 5.0 times or less.

3. The power storage device packaging material according to claim 1, wherein the barrier layer is formed of an aluminum alloy foil.

4. The power storage device packaging material according to claim 3, wherein the aluminum alloy foil has a thickness of 60 μm or more.

5. The power storage device packaging material according to claim 1, further comprising an adhesive layer between the barrier layer and the heat-sealable resin layer.

6. The power storage device packaging material according to claim 1, wherein the laminate has a thickness of 70 μm or more.

7. A method for producing a power storage device packaging material, comprising the step of:
providing a laminate in which at least a base material layer, a barrier layer, and a heat-sealable resin layer are laminated in this order from an outer side,
wherein the barrier layer has a thickness of 38 μm or more;
the laminate has a bending resistance of 1.1 mN or more, as measured under the following conditions in accordance with the provisions of JIS L1085: 1998:
<Conditions for measuring the bending resistance>
a Gurley stiffness tester is used; a sample size is 25 mm (MD)×51 mm (TD); the width of 51 mm is chucked; a weight of 25 g is used for measurement of a bending resistance of less than 2.0 mN, and a weight of 200 g is used for measurement of a bending resistance of 2.0 mN or more; five measurements are performed for each of left and right directions, at a rotation speed of 2.0 rpm; and an average of a total of 10 measured values is determined as the bending resistance; and
the number of double folds until a pinhole is formed in the laminate is 600 or more, as measured under the following conditions in accordance with the provisions of JIS P8115: 2001:
<Conditions for measuring the number of double folds until a pinhole is formed>
an MIT folding endurance tester is used, and the number of double folds until a pinhole is formed is measured under the following conditions: a sample size of 150 mm (MD)×15 mm (TD); a load of 1000 g; a folding angle of 45°; a folding speed of 175 times/min; and a chuck shape with an edge radius R of 0.38 mm.

8. A power storage device comprising a power storage device element comprising at least a positive electrode, a negative electrode, and an electrolyte,
wherein the power storage device element is housed in a package formed of the power storage device packaging material according to claim 1.

9. The power storage device packaging material according to claim 2, wherein the barrier layer is formed of an aluminum alloy foil.

10. The power storage device packaging material according to claim 9, wherein the aluminum alloy foil has a thickness of 60 μm or more.

11. The power storage device packaging material according to claim 2, further comprising an adhesive layer between the barrier layer and the heat-sealable resin layer.

12. The power storage device packaging material according to claim 2, wherein the laminate has a thickness of 70 μm or more.

13. A power storage device comprising a power storage device element comprising at least a positive electrode, a negative electrode, and an electrolyte,
wherein the power storage device element is housed in a package formed of the power storage device packaging material according to claim 2.
